(19) United States
(12) Patent Application Publication
(10) Pub. No.: US 2003/0203491 A1
(43) Pub. Date: Oct. 30, 2003

(54) Gravitational flow purification system

(76) Inventors: Zygmunt M. Andrevski, Princeton, NJ (US); Ravi Mehra, Princeton, NJ (US); Wayne Chaung, New Hyde Park, NY (US); Zvi Loewy, Fair Lawn, NJ (US)

Correspondence Address: FROMMER LAWRENCE & HAUG, 745 FIFTH AVENUE- 10TH FL., NEW YORK, NY, 10151, US

(21) Appl. No.: 10/132,944

(22) Filed: Apr. 26, 2002

(51) Int. Cl. G01N 35/00; G01N 1/00

(52) U.S. Cl. 436/46; 422/63; 422/100; 436/175

(57) ABSTRACT

The present invention relates to a gravitational flow purification system. More particularly, the invention relates to a process for purifying or isolating one or more substances from samples comprising said substances. Even more particularly, the invention relates to purifying or isolating macromolecules from biological samples using a gravitational flow apparatus.

### FIELD OF THE INVENTION

The present invention is directed to purification of one or more substances from samples comprising said one or more substances. More particularly, the invention is directed to purification of substances from biological samples comprising said substances. Even more particularly, the invention provides for an apparatus and method for the collection, storage and purification of macromolecules, such as DNA and RNA, from biological samples in an automated manner.

Documents cited herein in the following text are incorporated by reference.

### BACKGROUND OF THE INVENTION

In the field of molecular biology, there is an ever increasing number of uses for isolated biological macromolecules, such as DNA, RNA and proteins. Isolated biological macromolecules may be used, for example, to identify genetic defects, diagnose diseases, develop new drugs or treatments, and study gene expression. Purified nucleic acids are derived from biological material samples, such as whole blood, plasma, blood serum, urine, feces, saliva, sperm, tissue, cells, and other body fluids, materials, or plant tissue.

There are many known methods for extracting biological macromolecules from biological materials. In fact, a number of specialized techniques have been developed for isolation and purification of DNA and RNA from various cell lines and tissue types. Most isolation and purification protocols, however, involve combinations and variations of a few basic steps.

Generally, the first step of an isolation protocol is to harvest tissue or collect cells from the biological material sample. A small portion of the biological material is placed in a container, such as a test tube or well of a multi-well tray. The sample is mixed with a lysis buffer solution that causes the cell structure of the biological material to break down and dissolve. This process is known as lysing. The type of lysis buffer used will depend on many factors including the type of biological material, the specific isolation protocol, and how the resulting biological macromolecule will be used once it is isolated.

After lysing, DNA, RNA, and proteins may be isolated from the lysed-cell mixture by, for example, precipitation, centrifugation, filtration, or affinity complex. Isolation protocols may also require multiple iterations of one or a combination of these techniques. Separation of the desired biological macromolecule may require, for example, that the mixture be incubated. The biological macromolecule may be separated from the liquid forming a precipitate or “pellet.” The remaining fluid can then be aspirated, or pipetted, from the vial or well leaving the biological macromolecule. Alternatively, the macromolecule may be filtered from the remaining fluid. Once the macromolecule is isolated from the biological material, it often must be further purified to remove the effects of the lysing materials. Additionally, for some uses, the isolated macromolecule may be diluted. Examples of conventional RNA, DNA, protein isolation and purification protocols may be found in the Kaufman et al., Handbook of Molecular and Cellular Methods in Biology and Medicine, CRC Press, 1995, pp. 1-63, which is expressly incorporated herein by reference. These processes and other concepts of molecular biology are discussed in more detail in Sambrook et al, Molecular Cloning: A Laboratory Manual, Cold Spring Harbor Laboratory Press (2.sup.nd Ed.), 1989, which is also expressly incorporated herein by reference.

The elucidation of the human genome sequence has created the foundation for comprehensive genome analysis. Microarray expression analysis, DNA diagnostics and gene-based drug discovery, among others, rely on knowledge of and access to the genome sequence. The human genome contains approximately three billion base pairs contained within twenty-four separate chromosomes. The average gene contains 3000 base pairs, and the human genome contains approximately 30,000 genes. Human chromosome mapping has recently been completed. This massive effort resulted in the confirmation that only about ten percent of the base sequences on a chromosome provide templates for genetic information. The function of the remaining base sequences is not yet known.

The Human Genome Project recently elucidated the entire DNA sequence of the human genome, and a huge amount of research is now under way to identify the function of specific genes. It is widely believed that this research will have an immediate and profound effect on future understanding of biological processes and on the diagnosis and treatment of medical conditions.

In particular, the technology of genotyping is developing at a rapid pace. This technology maps the specific section of a gene that, when the sequence of bases in that section changes, causes a corresponding defect in the protein or other material synthesized from the gene. These areas of the gene are called single-nucleotide polymorphisms, or SNPs. SNPs can be used to predict if an individual is likely to develop a certain disease or if certain drugs will be effective when administered to the individual. This is of immense interest to pharmaceutical companies since the SNPs that control response to a drug can be used to develop tests to screen patients before the drug is prescribed and could be used to reduce the risk of adverse drug reactions by identifying susceptible individuals. Research and investigation for new drugs will also be streamlined, since knowledge of SNPs will help define new drugs and will help determine and document whether a drug will be effective.

Description of the human genome has created virtually overnight a plethora of methods for studying DNA or RNA segments and for rapidly examining nucleic acid sequences from test subjects. The term “genomics” has been created to describe this rapidly advancing technology.

The field of genomics can be divided into two major areas. Functional genomics attempts to interpret the function of genes, including investigation of gene expression and gene control. Comparative genomics studies the human genome in comparison to the genomes of non-humans. This often aids in determining the function of human genes and is useful in the study of evolutionary and biochemical pathways in organisms.

Another discipline, bioinformatics, has also developed. Bioinformatics is the science of tabulating and analyzing the huge amount of data that is a by-product of DNA analysis. The development of new computers and methods of data mining is an integral part of this technology.

The ability to utilize the genome sequence in the most efficient manner requires automation of every step. In addition to DNA sequence information, genomic technologies require purified nucleic acid. Nucleic acids are present in relatively small quantities, and the presence of other cellular components (such as proteins) can adversely affect the integrity of the experiment. Also, nucleic acids are present in all living organisms including bacteria, yeast and mold, and contamination with these and other ambient organisms must be avoided.

Nucleic acid isolation and purification is still largely done in small batches by a trained technician. This limits the ability to generate nucleic acid information, exposes the technician to infective agents, risks contamination of the samples and wastes resources. Moreover, the technician is limited to processing a small number of samples per day, yield is variable, and samples can be lost or switched. In many instances it is desirable to store samples and retrieve them for subsequent analysis. This requires space and equipment, and is often not feasible due to the instability of biological samples.

Commonly, sampling a biological specimen such as blood is facilitated by aspirating a defined volume of blood from a container, usually a test tube, which has had its cap removed. Racks of uncapped specimen tubes are common to many clinical laboratories. The defined volume of blood is then individually processed through a variety of steps to yield purified nucleic acid. Current processing steps include cell lysis, extraction of nucleic acid and subsequent purification. Current extraction and purification methods frequently require organic reagents such as phenol, ether and chloroform, thermal incubations, centrifugation and magnetic separation.

Another limitation of nucleic acid purification is sample size. Large volumes of samples such as blood are frequently processed in current clinical laboratories. This limits the application of genomic sequence information to samples such as those obtained in a forensic situation where often only small amounts of sample are available.

Several semi-automated methods of sample processing are available, but still require human intervention and are not high throughput. U.S. Pat. No. 5,270,211. Automated systems are not widely used; they are inflexible and prohibitively expensive. The systems are typically used in dedicated high-volume applications such as a genetic testing laboratory for isolating and purifying DNA from a particular type of specimen. These systems are generally not used in small laboratories where different nucleic acids are extracted from various sample types on a day-to-day basis.

Likewise, methods of nucleic acid purification have been streamlined but still require human intervention and yields are variable. For instance, comparing three RNA isolation kits showed a wide range of results; the best results were obtained from the most time-consuming kit. None of the kits was automated and all required exposure of the technician to the biological specimen. Scheibner et al. (2000) Deutsche Tier. Woch. 107:431-437.

Certain other methodologies provide kits or methods for individual components of sample handling and processing; none of these provides hands-free nucleic acid isolation. These include, but are not limited to, sample handling (WO 9853912; and U.S. Pat. No. 5,464,541); sample processing (WO 200060352); cell lysis (WO 200073412; WO 200073413; and EP 99104360); DNA purification from bloodstain cards and analysis thereof (Belgrader et al. (1997) Lab Robotics and Automation 9:3-7, John Wiley & Sons, Inc. NY); DNA extraction (WO 200062023; EP 1026241; U.S. Pat. Nos. 5,846,493; 5,808,041; WO 9929703; WO 9922021; WO 9518851; and WO 9521178); RNA extraction (WO 200075302; and WO 9859076); cell harvesting (WO 200070040); nucleic acid analysis (WO 200024939; and WO 200079008); and nucleic acid archiving or storage (WO 200066606; and WO 200053807).

Once nucleic acids are purified, they are usually amplified to obtain a sufficient amount of material for study. Amplification technology allows a single strand of nucleic acid to be amplified to provide a multitude of copies for subsequent study. Since a single DNA molecule can be amplified, it is critical that all carryover and cross-contamination is avoided. Large-scale and high-throughput systems have not effectively addressed this.

There are many macromolecular purification protocols in the art. U.S. Pat. No. 6,020,186 relates to a device and a process for isolating nucleic acids by lysing intact cells and removing nucleic acids emerging from the lysed cells by the following steps: a) the cells are immobilized in a porous matrix, with the size of matrix voids being in the range of the type of cell to be lysed; b) the cells are lysed; c) the nucleic acids are fixated on the matrix surface, and subsequently d) are eluted.

U.S. Pat. Nos. 5,939,259 and 6,168,922 relate to devices and methods for the collection, storage, and purification of nucleic acids, such as DNA or RNA, from fluid samples for subsequent genetic characterization, primarily by conventional amplification methods. The devices can be used to collect, store, or purify nucleic acids from a treated whole blood source that has naturally occurring nucleic acid amplification inhibitors present, as well as added blood stabilization components that also inhibit nucleic acid amplification. The nucleic acids can be released after collection or storage in a manner for amplification by conventional techniques such as polymerase chain reaction. An absorbent material that does not bind nucleic acids irreversibly is impregnated with a chaotropic salt. A biological source sample is contacted with the impregnated absorbent material. Nucleic acids present in the biological source can be either eluted or resolubilized off the absorbent material.

U.S. Pat. No. 5,807,527 relates to a solid medium for storage of DNA, including blood DNA, comprising a solid matrix having a compound or composition which protects against degradation of DNA incorporated into or absorbed on the matrix. The invention is also purported to store DNA using this solid medium, and for recovery of DNA or in situ use of DNA.

U.S. Pat. No. 5,756,126 relates to a dry solid medium for storage of genetic material, including RNA and DNA, in a form suitable for subsequent analysis. The invention also relates to a dry solid medium including components which function in subsequent analysis of the genetic material using, for example, PCR, reverse transcriptase initiated PCR, or genetic hybridization. It is purported that the components for subsequent analysis include, for example, nucleotide sequences such as a primer and a target sequence stabilizer. The invention further relates to methods for using the dry solid medium of the invention, and it is purported that the methods disclosed are suited for analysis in automated systems.

U.S. Pat. No. 5,496,562 relates to a solid medium for storage of DNA, including blood DNA, comprising a solid matrix having a compound or composition which protects against degradation of DNA incorporated into or absorbed on the matrix. The invention is also purported to disclose methods for storage of DNA using this solid medium, and for recovery of DNA or in situ use of DNA.

WO 00/62023 relates to a substrate for lysing cells and purifying nucleic acids having a matrix and a coating and an integrity maintainer for maintaining the purified nucleic acid. It is purported that the method of purifying nucleic acids consists of applying a nucleic acid sample to a substrate having an ionic detergent affixed to a matrix, whereby the substrate physically captures the nucleic acid, bonds the nucleic acid to the substrate and generates a signal indicating the presence of the nucleic acid. The invention also relates to a kit for purifying nucleic acids containing a coated matrix and an integrity maintenance provider for preserving the matrix.

WO 00/66606 relates to a substrate for purifying nucleic acid and enriching for populations of nucleic acids from a single cell source consisting of a matrix and anionic detergent affixed thereto. The purported method for isolating and archiving nucleic acid utilizing the matrix includes applying the nucleic acid sample to the substrate, the substrate physically capturing the nucleic acid and bonding the nucleic acid to the substrate.

WO 00/53807 relates to a medium for storage and subsequent analysis of genetic material. In particular, the invention relates to the storage and purification of nucleic acids from a biological mixture of molecules in a fluid phase on a support.

WO 00/04195 relates to a solid medium or matrix for storage of nucleic acid molecules, particularly vectors and plasmids. The invention comprises a solid matrix having a compound for protecting against degradation of nucleic acids on the substrate. The invention also relates to methods of storage or isolation/purification of nucleic acids and in situ use of the stored or isolated/purified nucleic acids.

WO 99/39009 relates to processes for isolating and amplifying DNA from biological materials. It is purported that reagents, methods, and kits are provided that incorporate a solid support for purifying, amplifying and characterizing DNA from liquid and dried biological samples.

WO 99/38962 relates to compositions and methods for using a lysing matrix for isolating DNA from biological materials. It is purported that reagents, methods, and kits are provided that incorporate a solid support for purifying, amplifying and characterizing DNA from liquid and dried biological samples.

WO 99/39010 relates to eluting reagents and methods for isolating DNA from biological materials.

WO 00/66267 relates to a system that prevents cross-contamination in a multi-well sample processing system. The system is said to include a multi-holed filter or absorbent matrix member positioned between a top flow-through plate and a bottom collection plate. The top plate has openings and nozzles and the bottom plate has openings which match and correspond to the openings in the matrix member. The matrix member prevents cross contamination between the bottom plate wells or across the nozzles. It is purported that cross contamination is prevented between the unsealed nozzles of the top plate and the unsealed wells of the bottom plate.

WO 00/49557 relates to a computer program module and computer system for issuing controls to an automated DNA isolation apparatus. It is purported that the program includes a series of sub-program modules for controlling the operation of generic processes of DNA isolation. The sub-modules may be used to construct an automated DNA isolation protocol specific to the user's purpose.

The current state of the art for purifying nucleic acids from biological samples is to spot on the biological sample onto modified membranes and to punch out a portion of the membrane containing the biological sample. Mechanical manipulation of the punched-out membrane is performed purify the nucleic acids affixed onto the membrane.

One of the disadvantages of the art is that a technician may improperly punch out the surface area of the membrane for analysis. For example, one may punch out less surface area, thereby losing sample, or punch out more area, thereby having more surface area exposed to the solution. In other words, one of the problems with the art is that one cannot have repeatable and reproducible surface area of blood that is exposed to all these chemicals during the purification steps.

Other separation methods include, for example, vacuum filtration, centrifugation, electrophoresis, magnetics and aspiration and dispensing. Each of these processes have inherent disadvantages and technical limitations. For example, foaming and migration occur when vacuum systems are utilized. Other problems associated with vacuum systems include low reliability, inability to perform purification of multiple samples in parallel, swelling of the sample, and resistance to flow.

There are also disadvantages associated with centrifugation and aspiration/dispensing. With respect to centrifugation, the disadvantages include, for example, lack of sample balance and limitation of batch size. With respect to aspiration/dispensing, the disadvantages include, for example, cross-contamination, aerosolization, material destruction and multiple disposables.

Indeed, representative disadvantages common to most or all of the known separation and purification processes include cross-contamination, complexity of the protocol, low system reliability, low batch sizes, lack of reproducibility and lack of scalability.

Consequently, a need exists in the art for uniformity of samples, reproducibility, purification and contamination control. A need also exists in the art to assure that a fixed surface area is exposed to the solution at the same time so that one can have a fixed amount of blood or specimen that will be analyzed and purified. A further need exists to safely transport biological samples without classification as a biohazard.

In contrast to the prior art, the present invention provides a gravitational flow system which minimizes and/or eliminates the above disadvantages and providing for exceptional contamination control.

### OBJECTS OF THE INVENTION

Therefore, it is an object of the invention to provide a device and method for purifying or isolating one or more substances from samples comprising said one or more substances having uni-directional liquid flow for exceptional contamination control.

It is an another object of the invention to provide a device and method for purifying substances from samples comprising said substances that can be used in both small scale, e.g., bench or laboratory, systems as well as large scale, e.g., industrial, systems.

It is a further objective of the invention to provide a device and method for purifying substances from samples comprising said substances, whereby the purification can be performed under ambient conditions.

It is still another objective of the invention to provide a device and method for purifying substances from samples comprising said substances having instrumentation with reduced complexity, improved system reliability, and minimal physical contact between the sample and the apparatus.

It is yet another objective of the invention to transport a device having the sample removably bound thereto in a safe, efficient and non-biohazardous manner under ambient conditions.

It is still another objective of the invention to construct a genomics library with a plurality of purified nucleic acid removably bound to a substrate.

Various other objects, advantages and features of the present invention will become readily apparent from the ensuing detailed description.

### SUMMARY OF THE INVENTION

In accordance with one embodiment of the present invention, a device is provided to treat a biological sample, comprising a reaction chamber with top and bottom ends, said reaction chamber adapted to receive a substrate and a fluid, said substrate adapted to receive the biological sample and adapted to be in contact with the fluid when the fluid is in the reaction chamber, said reaction chamber having an aperture, positioned substantially at the bottom end of the reaction chamber, that is selectively opened or closed such that in the closed position the reaction chamber retains the fluid and in the opened position the reaction chamber allows the fluid to leave the reaction chamber solely by gravity.

In accordance with another embodiment of the present invention, a method is provided for purifying or isolating a substance from a biological sample utilizing gravitational flow, said method comprising contacting the substance with a substrate and treating the substrate in a device comprising a reaction chamber with top and bottom ends, said reaction chamber adapted to receive a substrate and a fluid, said substrate adapted to receive the biological sample and adapted to be in contact with the fluid when the fluid is in the reaction chamber, said reaction chamber having an aperture, positioned substantially at the bottom end of the reaction chamber, that is selectively opened or closed such that in the closed position the reaction chamber retains the fluid and in the opened position the reaction chamber allows the fluid to leave the reaction chamber solely by gravity, whereby the sample is contacted onto the substrate before or while the substrate is inside the reaction chamber.

In accordance with still another embodiment of the present invention, an apparatus is provided for purifying or isolating one or more substances from a sample comprising said one or more substances, comprising a) at least one gravity flow washing station comprising: i) a reaction chamber comprising: 1) a hollow chamber for receiving said sample, said chamber comprising inner and outer walls and a top end with an orifice and a bottom end with an aperture; 2) an inlet for dispensing at least one washing reagent; and 3) an outlet for draining said washing reagent; and ii) a movable reaction chamber holding means removably engaged to said reaction chamber; and iii) a collection container for receiving the washing reagents on a movable base, wherein said collection container comprises a top with an opening, sides and bottom wherein a plunger is affixed to the bottom of the collection container, and the reaction chamber passes through the opening on the top of the collection container and comes into contact with the plunger, and said base and said reaction chamber holder move, independent of each other or together, horizontally, vertically or diagonally, or combinations thereof; and b) at least one gravity flow elution station comprising: a reaction chamber comprising: 1) a hollow chamber housed in an elution heating block, said hollow chamber comprising inner and outer walls and a top end with an orifice for receiving said substrate and, optionally, a bottom end with an aperture; and 2) an inlet for dispensing at least one elution reagent; wherein said elution station comprises sealing means and a cover removably engaged to said sealing means.

In accordance with another embodiment of the present invention, an apparatus is provided for purifying or isolating one or more substances from a biological sample comprising said one or more substances, comprising a) at least one lollypad comprising a substrate and handle means removably or fixedly engaged to a carrying rod, wherein said substrate comprises a matrix for removably binding the biological sample; b) a dispensing station comprising dispensing means for applying the biological sample onto the substrate of the lollypad; c) a transfer apparatus for transferring said lollypad from the dispensing station to a gravity flow reaction station and/or a gravity flow elution station; d) at least one gravity flow washing station comprising i) a reaction chamber comprising: 1) a hollow chamber for receiving said lollypad into said chamber and having inner and outer walls and a top end with an orifice and a bottom end with an aperture; 2) an inlet for dispensing at least one washing reagent; 3) an outlet for draining said washing reagent; and 4) optionally an inlet for adding hot air, ii) a movable reaction chamber holder removably engaged to said reaction chamber; and iii) a collection container for receiving the washing reagents on a movable base, wherein said container comprises a top with an opening, sides and bottom wherein a plunger is affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture of the hollow chamber; and e) at least one gravity flow elution station comprising: a reaction chamber comprising: 1) a hollow chamber housed in an elution heating block, said hollow chamber comprising inner and outer walls and an opening for receiving said lollypad; 2) an inlet for dispensing at least one elution reagent; and 3) optionally an inlet for adding hot air, wherein said elution heating block comprises sealing means and a cover removably engaged to said sealing means.

In accordance with another embodiment of the present invention, an apparatus is provided for purifying or isolating one or more substances from a sample comprising said one or more substances, comprising: a) at least one lollypad comprising a substrate and handle means removably or fixedly engaged to a carrying rod, wherein said substrate removably binds the sample; b) a dispensing station comprising dispensing means for applying the sample onto the substrate of the lollypad; c) a transfer apparatus for transferring said lollypad from the dispensing station to a gravity flow reaction station and/or a gravity flow elution station; d) at least one gravity flow washing station comprising: i) a reaction chamber comprising: 1) a hollow chamber for receiving said lollypad into said chamber and having inner and outer walls and a top end with an orifice and a bottom end with an aperture; 2) an inlet for dispensing at least one washing reagent; 3) an outlet for draining said washing reagent; and 4) optionally an inlet for adding hot air, ii) a movable reaction chamber holder removably engaged to said reaction chamber; and iii) a collection container for receiving the washing reagents on a movable base, wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture end of the hollow chamber; and e) at least one gravity flow elution station comprising: a reaction chamber comprising: 1) a hollow chamber housed in an elution heating block, said hollow chamber comprising inner and outer walls and a top end with an opening for receiving said lollypad; 2) an inlet for dispensing at least one elution reagent; and 3) optionally an inlet for adding hot air, wherein said elution heating block comprises sealing means and a cover removably engaged to said sealing means.

In accordance with yet another embodiment of the present invention, an apparatus is provided for collecting, storing or archiving one or more substances from a biological sample comprising said one or more substances, comprising at least one lollypad comprising a substrate and handle means removably or fixedly engaged to a carrying rod, wherein said substrate removably binds the biological sample; a dispensing station comprising dispensing means for applying the biological sample onto the substrate of the lollypad; and an identification element for identifying said lollypad.

In accordance with still another embodiment of the present invention, an apparatus is provided for purifying, isolating, collecting, storing or archiving one or more substances from a biological sample comprising said one or more substances, comprising: i) a reaction chamber comprising: 1) a hollow chamber for receiving said lollypad into said chamber and having inner and outer walls and a top end with an orifice and a bottom end with an aperture; 2) an inlet for dispensing at least one washing reagent; 3) an outlet for draining said washing reagent; and 4) optionally an inlet for adding hot air, ii) a movable reaction chamber holder removably engaged to said reaction chamber; and iii) a collection container for receiving the washing reagents on a movable base, wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture of the hollow chamber.

In yet still another embodiment of the present invention, an apparatus is provided for purifying, isolating, collecting, storing or archiving one or more substances from a biological sample comprising said one or more substances, comprising: a reaction chamber comprising a hollow chamber housed in a heating block, said hollow chamber comprising inner and outer walls and a top end with an opening for receiving said lollypad; an inlet for dispensing at least one elution reagent; and optionally an inlet for adding hot air, and wherein said elution heating block comprises sealing means and a cover removably engaged to said sealing means.

In a further embodiment of the present invention, an apparatus is provided for purifying or isolating one or more substances from a biological sample contained on a lollypad, comprising: a) a transfer apparatus for transferring said lollypad from the dispensing station to a gravity flow reaction station and/or a gravity flow elution station; b) at least one gravity flow washing station comprising: i) a reaction chamber comprising: 1) a hollow chamber for receiving said lollypad into said chamber and having inner and outer walls and a top end with an orifice and a bottom end with an aperture; 2) an inlet for dispensing at least one washing reagent; 3) an outlet for draining said washing reagent; and 4) optionally an inlet for adding hot air, ii) a movable reaction chamber holder removably engaged to said reaction chamber; and iii) a collection container for receiving the washing reagents on a movable base, wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture of the hollow chamber; and c) at least one gravity flow elution station comprising: a reaction chamber comprising: 1) a hollow chamber housed in an elution heating block, said hollow chamber comprising inner and outer walls and a top end with an opening for receiving said lollypad; 2) an inlet for dispensing at least one elution reagent; and 3) optionally an inlet for adding hot air, wherein said elution heating block comprises sealing means and a cover removably engaged to said sealing means.

In yet a still further embodiment of the present invention, an apparatus is provided comprising a rod assembly and a plurality of lollypads, comprising a substrate and a handle means, said handle means comprising a connection means which connects the lollypad to the handle.

In an another embodiment of the present invention, a method is provided for purifying or isolating one or more substances from a biological sample comprising said one or more substances, comprising: a) dispensing an aliquot of the biological sample, from a dispensing station comprising dispensing means, onto a substrate on at least one lollypad, wherein said lollypad comprises handle means removably engaged to a carrying rod; b) transferring the lollypad containing the biological sample to at least one gravity flow washing station, said station comprising: i) a reaction chamber comprising: 1) a hollow chamber for receiving said lollypad into said chamber and having inner and outer walls and a top end with an orifice and a bottom end with an aperture; 2) an inlet for dispensing at least one washing reagent; 3) an outlet for draining said washing reagent; and 4) optionally an inlet for adding hot air, ii) a movable reaction chamber holder removably engaged to said reaction chamber; and iii) a collection container for receiving the washing reagents on a movable base, wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture of the hollow chamber; c) washing the substrate one or more times by dispensing the washing reagent into the hollow chamber when the plunger is engaged to the chamber, allowing the reagent to come into contact with the substrate, disengaging the plunger from the chamber thereby releasing the reagent into the disposal chamber, and, optionally, drying the sample with air; d) optionally repeating step c); e) transferring the substrate to at least one gravity elution station for eluting the substance from the substrate, said elution station comprising a reaction chamber comprising: 1) a hollow chamber housed in an elution heating block, said hollow chamber comprising inner and outer walls and an opening for receiving said lollypad; 2) an inlet for dispensing at least one elution reagent; and 3) optionally an inlet for adding hot air, wherein said elution heating block comprises sealing means and a cover removably engaged to said sealing means.

In yet still another embodiment of the present invention, a method is provided for collecting, storing or archiving one or more substances from a biological sample comprising said one or more substances, comprising dispensing an aliquot of the biological sample, from a dispensing station comprising dispensing means, onto a substrate on at least one lollypad, wherein said lollypad comprises handle means removably engaged to a carrying rod; and identifying said lollypad with an identification element.

In a still yet another embodiment of the present invention, a gravity flow elution station is provided for purifying, isolating, collecting, storing or archiving one or more substances from a biological sample comprising said one or more substances, comprising a reaction chamber comprising a hollow chamber housed in an elution heating block, said hollow chamber comprising inner and outer walls and a top end with an opening for receiving a substrate; an inlet for dispensing at least one elution reagent; and optionally an inlet for adding hot air, wherein said elution heating block comprises sealing means and a cover removably engaged to said sealing means.

In a further embodiment of the present invention, an apparatus is provided for purifying, isolating, collecting, storing or archiving one or more substances from a biological sample comprising said one or more substances, comprising a collection container for receiving washing reagents on a movable base, wherein said container comprises a top with an opening, sides and bottom wherein a plunger affixed to the bottom of the container comes into contact with an aperture on a reaction chamber, said reaction chamber passing through the opening on the top of the container and held by a reaction chamber holder, wherein said base and said reaction chamber holder move, independent of each other or together, horizontally, vertically or diagonally in order for the plunger to seal or open the aperture of the reaction chamber.

These and other embodiments of the invention are provided in or are obvious from the following detailed description of the invention.

### BRIEF DESCRIPTION OF THE DRAWINGS

The following detailed description given by way of example, but not intended to limit the invention solely to the specific embodiments described, may best be understood in conjunction with the accompanying drawings in which:

FIG. 1a is a front elevational view of the carrying rod assembly comprising the substrates in accordance with the teachings of one embodiment of the present invention.

FIG. 1b is a side cross-sectional view of the carrying rod assembly of FIG. 1a.

FIG. 2a is a front elevational view of the carrying rod assembly comprising the substrates in accordance with the teachings of another embodiment of the present invention

FIG. 2b is a side cross-sectional view of the carrying rod assembly of FIG. 2a.

FIG. 3a is a side view of dispensing an aliquot of a biological sample onto the substrate in accordance with the teachings of one embodiment of the present invention.

FIG. 3b is a view of the dispensing station in accordance with the teachings of one embodiment of the present invention.

FIG. 4 is a cross-sectional view of the reaction station in accordance with the teachings of one embodiment of the present invention.

FIG. 5a is a cross sectional view of an elution station in accordance with the teachings of one embodiment of the present invention.

FIG. 5b is a cross sectional view of an elution station in accordance with the teachings of another embodiment of the present invention.

FIG. 6 is a front cross sectional view of a preferred embodiment of the elution station in accordance with the teaching of the present invention.

FIG. 7 is a view of an array of reaction chambers in accordance with the teachings of one embodiment of the present invention.

FIG. 8 is a view of an array of elution stations in accordance with the teachings of one embodiment of the present invention.

FIG. 9 is a representation of the results of gel electrophoresis of PCR amplicons derived from target genomic DNA purified from a blood sample in accordance with the teachings of the present invention.

FIGS. 10a and 10b are cross-sectional views of a hanger bracket in accordance with the teachings of one embodiment of the present invention.

FIG. 11 is a cross-sectional view of the device for the treatment of a biological sample in accordance with the teachings of one embodiment of the present invention.

FIG. 12 is a cross-sectional view of the device for the treatment of a biological sample in accordance with the teachings of another embodiment of the present invention.

### DETAILED DESCRIPTION

The embodiments of the present invention can be used to purify or isolate substances from samples comprising those substances, particularly to purify or isolate macromolecules from biological samples and, more particularly to purify or isolate nucleic acids from blood.

The source of the substance, preferably of the nucleic acid, can be a biological sample obtained from eukaryotic or prokaryotic cells or sub-cellular preparations, from cells or sub-cellular preparations taken or obtained from tissues of multicellular organisms including animals and plants, or from virus-containing preparations. The source of the samples can be, but is not restricted to, blood, cells, sub-cellular preparations, bacterial culture, bacterial colonies, virus-containing preparations, saliva, urine, drinking water, semen, plasma, stool samples, sputum, embryo/fetal tissue, chemicals, metallic compounds, or a mixture of any of the foregoing. In one embodiment, the present invention can be used to purify cells or to sort cells.

The present invention is directed to a gravitational flow purification process and apparatus. Specifically, the present invention is directed to an apparatus and process for isolating or purifying one or more substances from samples comprising the substances. More specifically, the present invention is directed to a process for purifying macromolecules from biological samples using a gravitational flow apparatus, comprising the steps of placing an aliquot of the biological sample onto a substrate using a dispensing means, lysing the biological sample, washing the biological sample and eluting the macromolecules.

In a preferred embodiment, the present invention is directed to a purification process using a gravitational flow apparatus for purifying one or more substances from a sample comprising said one or more substances. Thus, an apparatus is provided for purifying or isolating one or more substances from a sample comprising said one or more substances, comprising a) at least one gravity flow washing station comprising: i) a reaction chamber comprising: 1) a hollow chamber for receiving said sample, said chamber comprising inner and outer walls and a top end with an orifice and a bottom end with an aperture; 2) an inlet for dispensing at least one washing reagent; and 3) an outlet for draining said washing reagent; and ii) a movable reaction chamber holding means removably engaged to said reaction chamber; and iii) a collection container for receiving the washing reagents on a movable base, wherein said collection container comprises a top with an opening, sides and bottom wherein a plunger is affixed to the bottom of the collection container, and the reaction chamber passes through the opening on the top of the collection container and comes into contact with the plunger, and said base and said reaction chamber holder move, independent of each other or together, horizontally, vertically or diagonally, or combinations thereof; and e) at least one gravity flow elution station comprising: a reaction chamber comprising: 1) a hollow chamber housed in an elution heating block, said hollow chamber comprising inner and outer walls and a top end with an orifice for receiving said substrate and, optionally, a bottom end with an aperture; and 2) an inlet for dispensing at least one elution reagent; wherein said elution station comprises sealing means and a cover removably engaged to said sealing means.

In a preferred embodiment, the substrate comes into contact with the inner walls of the hollow chamber of the washing station. More preferably, the substrate also comes into contact with the inner walls of the hollow chamber of the gravity flow elution station.

Preferably, the substrate is on at least one lollypad. The present invention can process up to 200 lollypads at the same time, preferably from about 100 to about 200 lollypads, most preferably from about 4 to 50 lollypads.

The substrate may be of any type known to be useful by the skill artisan, such as, treated membranes, untreated membranes, cellulosics, cellulose nitrate, cellulose acetate, nylon, glass fiber, electrically charged substrates such as corona, beads, silica, glass, plastics, clays, ceramics, resins, fibers, fabrics, microparticle beads, nanotubes, beads coated with oligonucleotide probes, antibody-coated beads, strepavidin-coated beads, protein-coated beads, beads coated with intercalating dyes, woven porous polymers, non-woven porous polymers, polyesters, polyolefins, and any combination thereof.

In a further preferred embodiment, the present invention is also directed to a device to treat a biological sample, comprising a reaction chamber with top and bottom ends, said reaction chamber adapted to receive a substrate and a fluid, said substrate adapted to receive the biological sample and adapted to be in contact with the fluid when the fluid is in the reaction chamber, said reaction chamber having an aperture, positioned substantially at the bottom end of the reaction chamber, that is selectively opened or closed such that in the closed position the reaction chamber retains the fluid and in the opened position the reaction chamber allows the fluid to leave the reaction chamber solely by gravity.

In an another preferred embodiment, the present invention is directed to a method for purifying or isolating a substance from a biological sample utilizing gravitational flow, said method comprising contacting the substance with a substrate and treating the substrate in a device comprising a reaction chamber with top and bottom ends, said reaction chamber adapted to receive a substrate and a fluid, said substrate adapted to receive the biological sample and adapted to be in contact with the fluid when the fluid is in the reaction chamber, said reaction chamber having an aperture, positioned substantially at the bottom end of the reaction chamber, that is selectively opened or closed such that in the closed position the reaction chamber retains the fluid and in the opened position the reaction chamber allows the fluid to leave the reaction chamber solely by gravity, whereby the sample is contacted onto the substrate before or while the substrate is inside the reaction chamber.

The washing reagent and the elution reagent, separately or together, are comprised of a buffer, a surfactant, water, organics, alcohols or combinations thereof. Preferably, the washing reagent and the elution reagent, either separately or together, are buffers.

The present invention can be used, for example, to detect pathogens such as bacteria, viruses, or other microorganisms that can be found in the circulatory system and other parts of the body. The present invention can also be used to detect nucleic acids. Preferably, the present invention is automated. Further still, the present invention can be used to generate a library of substances on a substrate, such as a library of nucleic acids on a substrate.

Once on the substrate, the samples, such as bacteria or virus, or macromolecules, such as nucleic acids, are substantially non-biohazardous and may be easily transportable under ambient conditions. Macromolecules, such as nucleic acids, can also be released after collection or storage in a manner that enables them to be amplified by conventional techniques such as PCR.

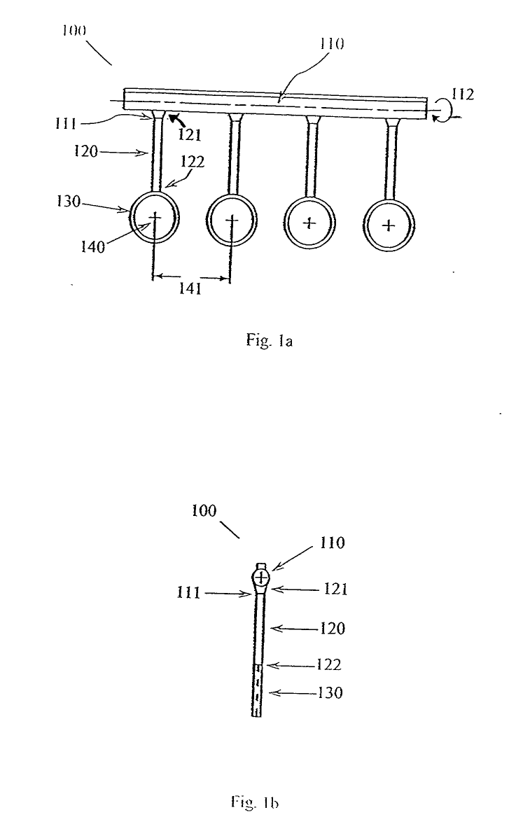

Reference is now made to the figures. FIG. 1a depicts rod assembly 100 according to the present invention. Rod assembly 100 may be utilized in a process for purifying macromolecules from biological samples.

With particular reference to FIG. 1, rod assembly 100 is described in greater detail. Carrying means 110 is made of any suitable material known in the art, such as, for example, metals, such as aluminum, polymers or copolymers, such as plastic, polypropylene and polyethylene, and is freely rotable about axis 112. A plurality of connection means 111 are affixed to carrying means 110. The connection means may be in any form readily known in the art such as, for example, a hook, screw or suction device and is made of any suitable material known in the art, such as, for example, metals, such as aluminum, polymers or copolymers, such as plastic, polypropylene or polyethylene. A plurality of handle means 120 are provided having top end 121 and bottom end 122. Handle means 120 may be configured in any form readily known in the art such and is made of any suitable material known in the art such as, for example, metals, such as aluminum, polymers or copolymers, such as plastic, polypropylene or polyethylene. Top end 121 of handle means 120 is engaged to connection means 111 of carrying rod 110. Bottom end 122 is engaged to frame 130. Frame 130 is made of any suitable material known in the art, including metals such as aluminum or polymers or copolymers and may be in any form known in the art, such as, for example, rectangular, circular or elliptical. Preferably, frame 130 approximates the shape of substrate 140.

Frame 130 functions to fixedly or detachably affix substrate 140. In a preferred embodiment, substrate 140 removably binds to nucleic acids. Many materials are suitable as the substrate. In this embodiment, the main characteristics needed for the substrate are that it is or can be made hydrophilic, bibulous, and does not substantially bind nucleic acids irreversibly through either hydrophobic, ionic, covalent, or electrostatic means. The substrate must not by itself inhibit or bind amplification reactants, release substances that effect amplification reactants or otherwise affect PCR and other amplification reactions. Suitable materials include FTA, cellulosics, woven porous polymers, or non-woven porous polymers, including polyesters, polypropylenes beads or combinations thereof. Substrate 140 may be obtained commercially from a number of manufacturers such as Whatman and Schleicher & Schuell and is the subject of, for example, U.S. Pat. Nos. 5,939,259, 6,168,922, 6,020,186, WO 00/62023 and WO 00/66606, all of which are incorporated herein by reference.

In a preferred embodiment, substrate 140 comprises reagents which lyse the biological source to expose the macromolecules contained therein. In this preferred embodiment, the reagents lyse blood cells, thereby exposing the DNA contained therein for removably binding substrate, for purification and for elution. Optionally, the lysing reagents may be added to the washing reagents.

The cells immobilized on or within the substrate are lysed preferably by physical or chemical action where lysis either may be effected mechanically, by shear forces, osmotic shock, or chemically using detergents or alkaline digestion. The cells may be lysed by lysing reagents either before, during or after application of the sample onto the substrate. Further, agitation may be provided by an agitation element to assist in lysis. The modes of agitation include, but are not being limited to, mechanical motion/vibration, ultrasonic, piezoelectric, magnetic, pulsating motion, vortex, pneumatic air or gas, hydraulic, aerating, encapsulated rotating magnets, rotating stirrers and paddles, orbital shakers or combinations thereof.

In a particularly preferred embodiment, the surface of the material forming the substrate has ion exchanging properties. Especially when using anion exchangers the nucleic acid emerging from the lysed cell may be bound removably to the material forming the substrate to be eluted by adjusting to high ionic strengths subsequent to various washing operations.

The shape or configuration of the substrate can vary. One can choose from, for example, flat sheets, such as rectangles, or circular shapes, such as circles as shown in FIG. 1a. A skilled artisan would readily understand, however, that the substrate can be in any three-dimensional shape or configuration.

Other reagents can be added to the present invention in order to enhance lysis or disruption of intact cells, bacteria or viruses absorbed onto the substrate. For example, suitable anionic, cationic, or zwitterionic surfactants, such as Tween 20 or Triton X-100, can be impregnated onto the substrate.

Carrying rod 110 may support a plurality of substrates 140, preferably between 4 and 100 substrates 140. Preferably, substrates 140 are in an array form. For small scale purification, it is envisioned that between 4 and 50 substrates 140 may be supported by carrying rod 110. For large scale purification, up to 100 substrates 140 may be supported by carrying rod 110. Pitch 141 is the distance between the approximate center points of each substrate 140 in a given carrying rod. The pitch 141 assists in aligning the substrate to the hollow chamber that will be discussed in greater detail below. In a preferred embodiment, a plurality of carrying rods 110 may be provided.

In a particularly preferred embodiment, carrying rod 110, connection means 111, handle means 120 and frame 130 are a single injection molded item.

FIG. 1b represents a side cross-sectional view of the elements of FIG. 1a.

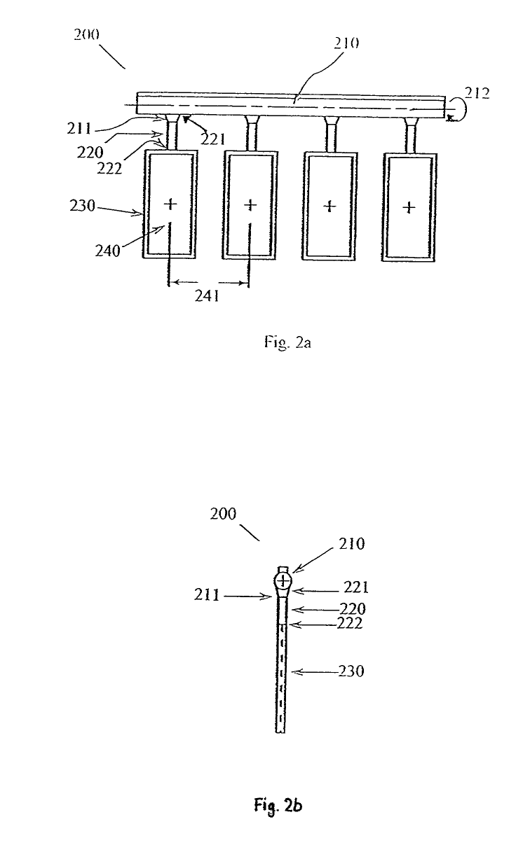

FIG. 2a is an alternate embodiment of the invention that is suitable for, for example, when a large substrate surface area is desirable. With reference to FIG. 2a, rod assembly 200 includes carrying means 210. Carrying means 210 is made of any suitable material known in the art, such as, for example, metals, such as aluminum, polymers or copolymers, such as plastic, polypropylene and is freely rotable about axis 212. A plurality of connection means 211 are affixed to carrying means 210. The connection means may be in any form readily known in the art such as, for example, a hook, screw or suction device and is made of any suitable material known in the art, such as, for example, metals, such as aluminum, polymers or copolymers, such as plastic, polypropylene. A plurality of handle means 220 having top end 221 and bottom end 222 are also provided. Handle means 220 is made of any suitable material known in the art such as, for example, metals, such as aluminum, polymers or copolymers, such as plastic, polypropylene. Top end 221 of handle means 220 is detachably or fixedly engaged to connection means 211 of carrying rod 210. Bottom end 222 is detachably or fixedly engaged to frame 230. Frame 230 is made of any suitable material known in the art, including metals such as aluminum or polymers or copolymers and may be in any form known in the art, such as, for example, rectangular, circular, elliptical. Preferably, frame 230 approximates the shape of substrate 240.

Frame 230 functions to detachably or fixedly affix substrate 240. In a preferred embodiment, substrate 240 removably binds to nucleic acids. Many materials are suitable as the substrate. The main characteristics needed for the substrate are that it is or can be made hydrophilic, bibulous, and does not substantially bind nucleic acids irreversibly through either hydrophobic, ionic, covalent, or electrostatic means. The substrate must not by itself inhibit or bind amplification reactants, release substances that effect amplification reactants or otherwise affect PCR and other amplification reactions. Suitable materials include FTA, cellulosics, woven porous polymers, or non-woven porous polymers, including polyesters and polypropylenes, beads or combinations thereof. Substrate 240 may be obtained commercially from a number of manufacturers such as Whatman and Schleicher & Schuell and is the subject of, for example, U.S. Pat. Nos. 5,939,259, 6,168,922, 6,020,186, WO 00/62023 and WO 00/66606, all of which are incorporated herein by reference.

Substrate 240 comprises reagents which lyse the biological source to expose the macromolecules contained therein. In a preferred embodiment, the reagents lyse blood cells, thereby exposing the DNA contained therein for purification and elution. The cells immobilized within the substrate are lysed preferably by physical or chemical action where lysis either may be effected mechanically such as by ultrasonic waves or by shear forces, osmotic shock, or chemically using detergents or alkaline digestion.

In a particularly preferred embodiment, the surface of the material forming the substrate has ion exchanging properties. Especially when using anion exchangers the nucleic acid emerging from the lysed cell may be bound removably to the material forming the substrate to be eluted by adjusting to high ionic strengths subsequent to various washing operations.

The shape or configuration of the absorbent material can vary. One can choose from, for example, flat sheets, such as rectangles as shown in FIG. 2a, or circular shapes.

Other reagents can be added to the present invention in order to enhance lysis or disruption of intact cells, bacteria or viruses absorbed onto the substrate. For example, suitable anionic, cationic, or zwitterionic surfactants, such as Tween 20 or Triton X-100, can be impregnated into or onto the substrate.

Carrying rod 210 may support a plurality of substrates 240, preferably between 4 and 100 substrates 240. For small scale purification, it is envisioned that between 4 and 50 substrates 240 may be supported by carrying rod 210. For large scale purification, up to 200 substrates 240 may be supported by carrying rod 210. Pitch 241 is the distance between the approximate center points of each substrate 240 in a given carrying rod. The pitch 241 assists in aligning the substrate to the chamber that will be discussed in greater detail below.

In a particularly preferred embodiment, carrying rod 210, connection means 211, handle means 220 and frame 230 are a single injection molded item.

With reference to FIG. 2b, a side cross-sectional view of the elements of FIG. 2a is presented.

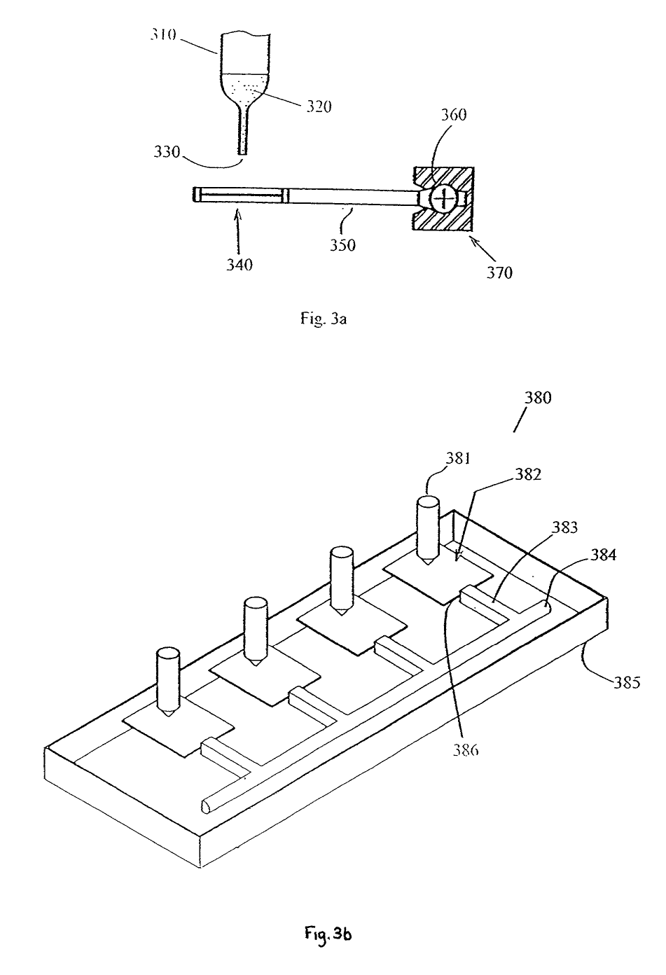

With reference to FIG. 3a, dispensing means 310 is used to place an aliquot of sample 320 onto substrate 340 through aperture 330. Dispensing means 310 may be any device suitable for dispensing aliquots of sample including, for example, a pipette, a dropper and a syringe. Dispensing means 310 may be constructed of any material that is non-reactive with biological sample 320 such as, for example, plastic, metal, and glass. Biological sample 320 is substantially in liquid form and comprises the macromolecules to be purified. The source of sample 320 may be chemical or biological, but is not restricted to, blood, cells, subcellular preparations, bacterial culture, bacterial colonies, virus-containing preparations, saliva, urine, drinking water, plasma, stool samples and sputum.

The volume of sample 320 dispensed may range from about 5 μl to about 1000 μl, preferably from about 50 μl to about 200 μl. Handle means 350 allows for secure attachment of substrate 340 to carrying means 360. Transfer apparatus 370 maintains substrate 340 in a substantially horizontal position, thereby exposing substantially all of the surface area of substrate 340 to dispensing means 310. Transfer apparatus 370 is made of any suitable material known in the art such as, for example, metals, such as aluminum, polymers or copolymers, such as plastic, polypropylene. Preferably, the transfer apparatus is robotic. Upon placement of an aliquot of sample 320 onto substrate 340, transfer apparatus 370 rotates 90 degrees downward to configure substrate 340 into a substantially vertical position for run-off of excess biological sample 320. In a preferred embodiment, only enough sample 320 is dispensed to be fully absorbed by the substrate.

With reference to FIG. 3b, dispensing station 380 is presented. Dispensing station 380 comprises dispensing means 381 which dispenses a sample onto substrate 382. Preferably, dispensing means 381 is a pipette. Substrate 382 is removably engaged to the bottom end of handle means 383 by connection means 386. The top end of handle means 383 is removably or fixedly, preferably fixedly, engaged to carrying means 384. Tray 385 collects any run-off of the sample dispensed from dispensing means 381.

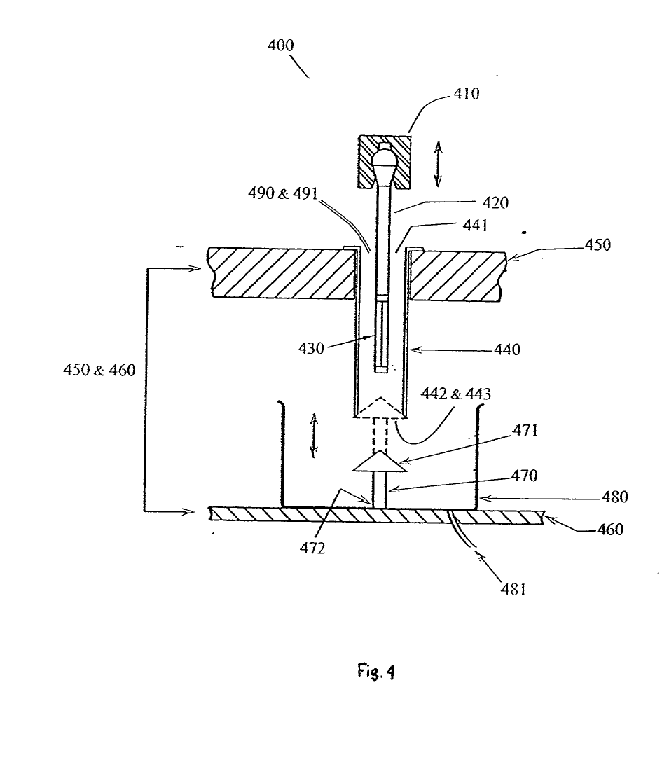

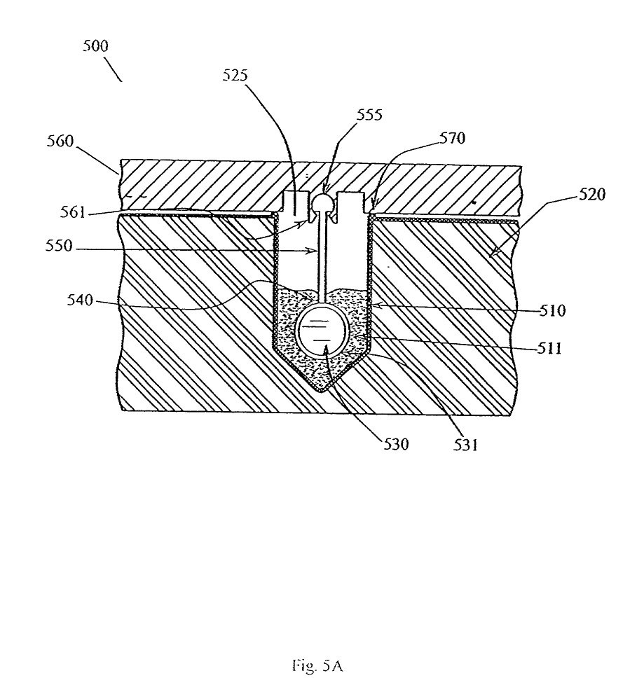

With reference to FIG. 4, transfer apparatus 410 transfers handle means 420 and substrate 430 from the dispensing station into reaction station 400. Transfer apparatus 410 is made of any suitable material known in the art such as, for example, metals, such as aluminum, polymers or copolymers, such as plastic, polypropylene. Preferably, the transfer apparatus is robotic. Reaction station 400 comprises chamber 440, which is substantially hollow, removably engaged to reaction chamber holding means 450. Reaction chamber holding means 450 is engaged to platform 460. Chamber 440 is in a substantially cylindrical and hollow configuration having inner and outer walls. Chamber 440 may be made from materials known to a skilled artisan, such as, for example, plastics or thermoplastic. Chamber 440 has top end 441 and bottom end 442. Top end 441 has an opening to accept substrate 430, and is wide enough so that substrate 430 does not have to come into contact with the inner wall of chamber 440. Bottom end 442 contains aperture 443 for removably engaging to plunger element 470. Plunger element 470 may be made from materials known to a skilled artisan, such as, for example rubber or plastic. Plunger element 470 preferably has sealing valve 471 for removably engaging to aperture 443 of chamber 440, and bottom end 472 for fixedly engaging to collection container 480. Collection container 480 may be made from materials known to a skilled artisan, such as, for example, plastic and is fixedly attached to platform 460. Collection container 480 optionally includes drain conduit 481.

Reaction station 400 further includes reagent conduit 490 and, optionally, air conduit 491. Reagent conduit 490 transfers washing reagents onto substrate 430 when plunger element 470 is fixedly engaged to aperture 443 of chamber 440. The reagent may be any reagent known in the art such as, for example, SDS, Tris and ETDA. In a preferred embodiment, a pump, preferably a peristaltic pump, may be added to the reaction station to recirculate the washing reagents in a continuous or intermittent manner. Air conduit 491 blows air onto substrate 430 either before or after transfer apparatus 410 places substrate 430 into chamber 440 and either before or during the transfer of reagents onto substrate 430. The transfer of air, either at elevated or ambient temperature, allows for drying of the biological sample on substrate 430 and prevents, for example, excess biological sample from entering chamber 440.

Further, transfer apparatus 410, reaction chamber holder 450 and platform 460 may move in the x-y-z direction. Movement in the x-y-z direction provides for sealing valve 471 of plunger element 470 to align with aperture 443. Movement in the x-y-z direction also provides for automated alignment of substrate 430 to chamber 440, thereby substantially avoiding contact of substrate 430 to the inner wall of chamber 440.

In a preferred embodiment, an agitation element is also provided. The agitation element may assist in, for example, the washing, lysing and elution processes. Such an agitation element includes, but is not limited to, mechanical, ultrasonic, magnetic or electromagnetic elements known to a skilled artisan. Preferred agitation elements include, but are not limited to, mechanical motion/vibration, ultrasonic, piezoelectric, magnetic, pulsating motion, vortex, pneumatic air or gas, hydraulic, aerating, encapsulated rotating magnets, rotating stirrers and paddles, orbital shakers or combinations thereof.

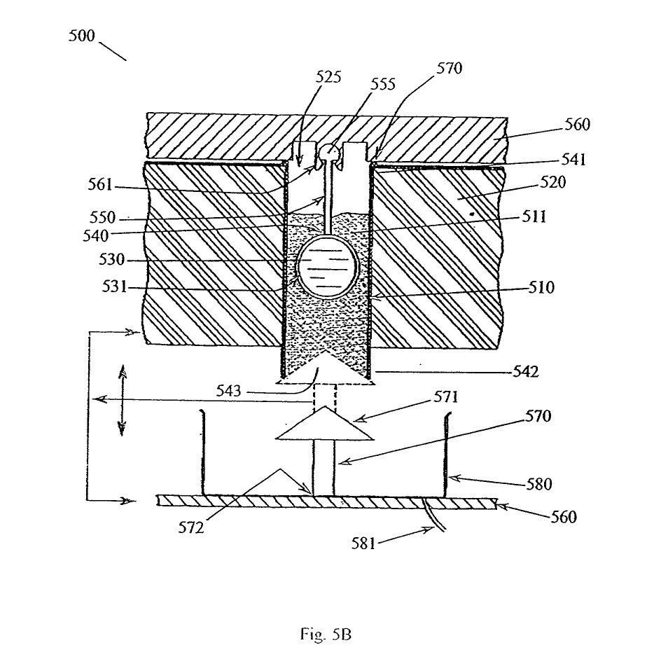

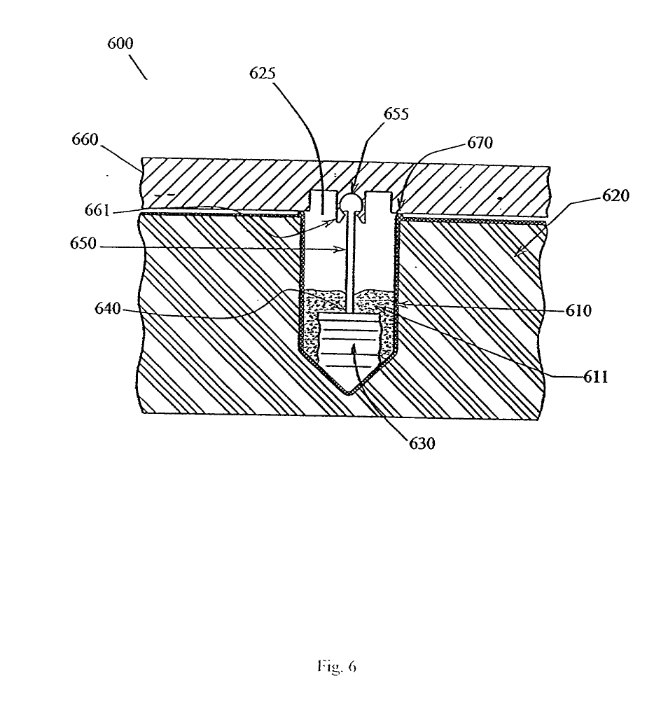

With reference to FIG. 5A, single chamber elution station 500 is presented. Elution station 500 comprises elution chamber 510 comprising elution reagent 511. Elution chamber 510 is contained in elution heating block 520. Elution chamber 510 comprises a top opening 525 to receive substrate 530 contained in frame 531, wherein substrate 530 does not have to come into contact with elution chamber 510. It is contemplated that elution chamber 510 may be either fixed in heating block 520 or removable from heating block 520. It is understood, however, that substrate 530 may be framed or un-framed. Handle means 550 engages substrate 530 via connecting means 540. Handle means 550 is attached to carrying rod 555. Cover 560 comprises carrying rod gripper 561 for engaging carrying rod 555. Cover 560 is removably affixed onto elution heating block 520 and sealed with seal rib 570. An example of heating block 520 is a Peltier heating block having a temperature range of from about 50° C. to about 95° C. In a preferred embodiment, seal rib 570 is integrally molded into or onto elution chamber 510.

With reference to FIG. 5B, single chamber gravity flow elution station 500 is presented. Gravity flow elution station 500 comprises elution chamber 510 comprising elution reagent 511. Elution chamber 510 is contained in elution heating block 520. Elution chamber 510 has a top end 541 and a bottom end 542. Top end 541 has an opening 525 to accept substrate 530, and is wide enough so that substrate 530 does not have to come into contact with the inner wall of chamber 510. Bottom end 542 contains aperture 543 for removably engaging to plunger element 570. Plunger element 570 may be made from materials known to a skilled artisan, such as, for example rubber or plastic. Plunger element 570 preferably has sealing valve 571 for removably engaging to aperture 543 of chamber 510 and bottom end 572 for fixedly engaging to collection container 580. Collection container 580 may be made from material known to a skilled artisan, such as, for example, plastic and is fixedly attached to platform 560. Collection container 580 optionally includes drain conduit 581.

Further, heating block 520 containing elution chamber 510 and platform 560, which is fixedly engaged to said collection container 580, may move in the x, y or z direction, or in any combination thereof. Movement in the x-y-z direction provides for, for example, sealing valve 571 of plunger element 570 to align with aperture 543. Movement in the x-y-z direction also provides for automated alignment of substrate 530 to elution chamber 510, thereby substantially avoiding contact of substrate 530 to the inner wall of elution chamber 510.

In a preferred embodiment, an agitation element is also provided. The agitation element may be used to, for example, assist in the washing, lysing and elution processes. Such agitation elements include, but are not limited to, mechanical, ultrasonic, magnetic or electromagnetic elements known to a skilled artisan. Preferred agitation elements include, but are not limited to, mechanical motion/vibration, ultrasonic, piezoelectric, magnetic, pulsating motion, vortex, pneumatic air or gas, hydraulic, aerating, encapsulated rotating magnets, rotating stirrers and paddles, orbital shakers or combinations thereof.

It is contemplated that elution chamber 510 may be either fixed in heating block 520 or removable from heating block 520. It is understood, however, that substrate 530 may be framed or un-framed. Handle means 550 engages substrate 530 via connecting means 540. Handle means 550 is attached to carrying rod 555. Cover 560 comprises carrying rod gripper 561 for engaging carrying rod 555. Cover 560 is removably affixed onto elution heating block 520 and sealed with seal rib 570. An example of heating block 520 is a Peltier heating block having a temperature range of from about 50° C. to about 95° C. In a preferred embodiment, seal rib 570 is integrally molded into or onto elution chamber 510.

With reference to FIG. 6, single-chamber elution station 600 is presented. Elution station 600 comprises elution chamber 610 comprising elution reagent 611. Elution chamber 610 is contained in elution heating block 620. Elution chamber 610 comprises a top opening 625 to receive substrate 630, wherein substrate 630 is allowed to be compressed against elution chamber 610. Handle means 650 engages substrate 630 via connecting means 640. Handle means 650 is attached to carrying rod 655. Cover 660 comprises carrying rod gripper 661 for engaging carrying rod 655. Cover 660 is removably affixed onto elution heating block 620 and sealed with seal rib 670.

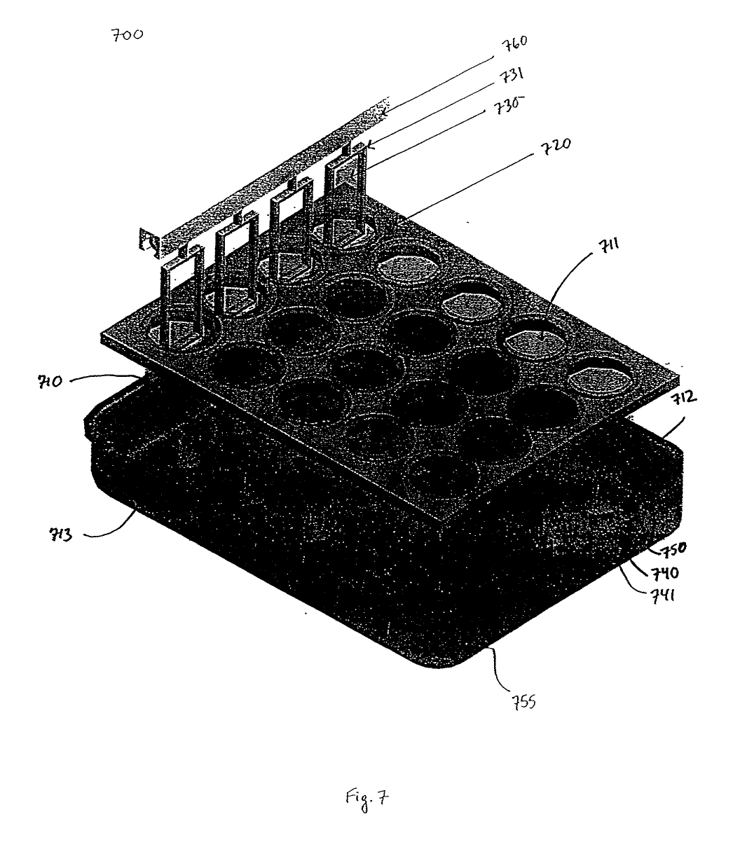

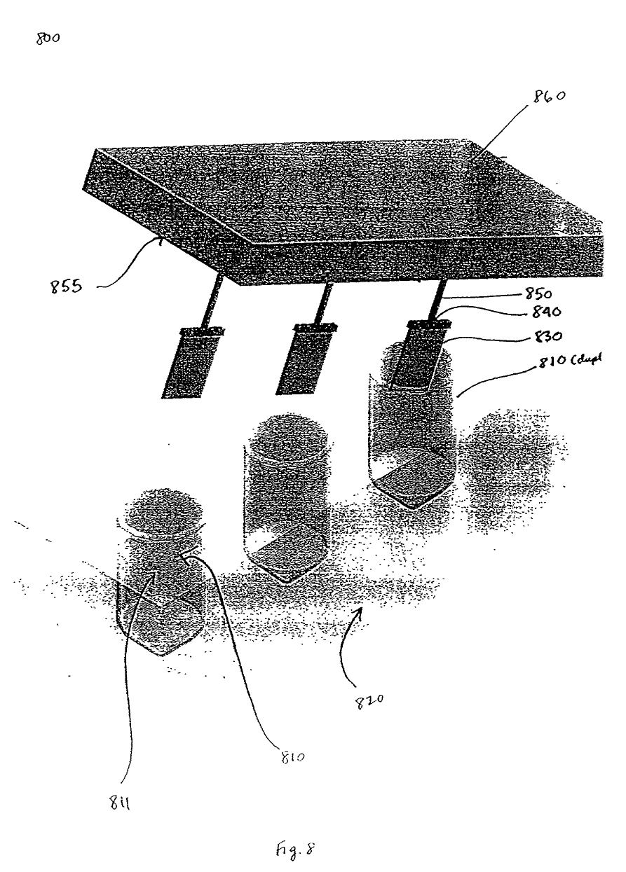

With reference to FIG. 7, multi-chamber reaction station 700 is presented. Station 700 comprises a plurality of reaction chambers 710 affixed onto reaction chamber holding means 720. Reaction chambers 710 are substantially hollow and removably engaged to reaction chamber holding means 720. Chambers 710 are in a substantially cylindrical and hollow configuration having inner and outer walls. Chambers 710 may be made from materials known to a skilled artisan, such as, for example, plastics or thermoplastic. Chamber 710 has top end 711 and bottom end 712. Top end 711 has an opening to accept substrate 730, and is wide enough so that substrate 730 does not come into contact with the inner wall of chamber 710. Substrate 730 is contained within frame 731. Bottom end 712 contains aperture 713 for removably engaging to plunger element 740. Plunger element 740 may be made from materials known to a skilled artisan, such as, for example rubber or plastic. Plunger element 740 preferably has sealing valve 750 for removably engaging to aperture 713 of chamber 710, and bottom end 741 for fixedly engaging to collection container 755. Collection container 755 may be made from materials known to a skilled artisan, such as, for example, plastic. Collection container 750 optionally includes a drain conduit (not shown here).

Reaction station 700 further includes a reagent conduit and, optionally, an air conduit (not shown here). The reagent conduit transfers washing reagents onto substrate 730 when plunger element 740 is fixedly engaged to chamber 710. The reagent may be any reagent known in the art such as, for example SDS, Tris and ethylenediamine-tetraacetic acid (EDTA). In a preferred embodiment, a pump (not shown), preferably a peristaltic pump, may be added to the reaction station to recirculate the washing reagents. The air conduit blows air onto substrate 730 either before or after transfer apparatus 760 places substrate 730 into chamber 710 and either before or during the transfer of reagents onto substrate 730. Transfer apparatus 760 is made of any suitable material known in the art such as, for example, metals, such as aluminum, polymers or copolymers, such as plastic, polypropylene. Preferably, the transfer apparatus is robotic. The transfer of air, either at elevated or ambient temperature, allows for drying of the sample on substrate 730 and prevents, for example, excess sample from entering chamber 710.

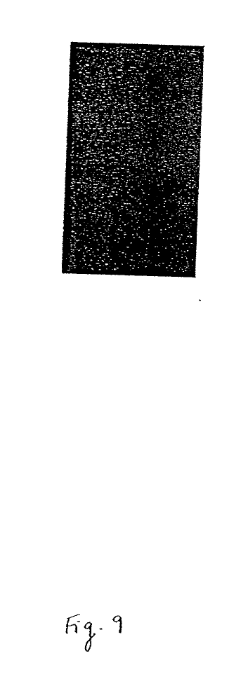

With reference to FIG. 8, multi-chamber elution station 800 is presented. Elution station 800 comprises a plurality of elution chambers 810 comprising elution reagent 811. Elution chamber 810 is contained in elution heating block 820. Elution chamber 810 comprises a top opening 820 to receive substrate 830. Handle means 850 engages substrate 830 via connecting means 840. Handle means 850 is attached to carrying rod 855. Cover 860 comprises carrying rod gripper (not shown) for engaging carrying rod 855. Cover 860 is removably affixed onto elution heating block 820 and sealed with a sealing rib (not shown).

With reference to FIG. 9, it is shown that the process and apparatus of the present invention provides for purified nucleic acids. The nucleic acids may be amplified, sequenced and analyzed by known techniques in the art. Such techniques are recited in, for example, Kolmodin et al., “Polymerase Chain Reaction: Basic Principles and Routine Practice,” The Nucleic Acid Protocols Handbook (2000); Huang et al., Clinical Chemistry, 47:10, 1912-1916 (2001); Martinsky et al., “Microarry Tools, Kits, Reagents and Services,” Microarry Biochip Technology (2000); Tonisson et al., “Arrayed Primer Extension on the DNA Chip: Method and Applications,” Microarray Biochip Technology (2000), all of which are incorporated herein by reference.

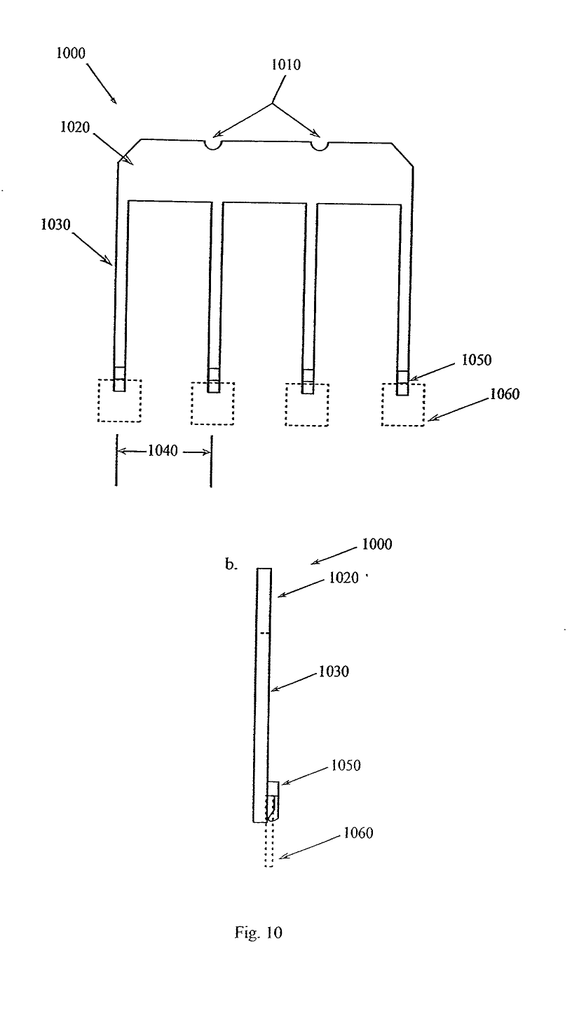

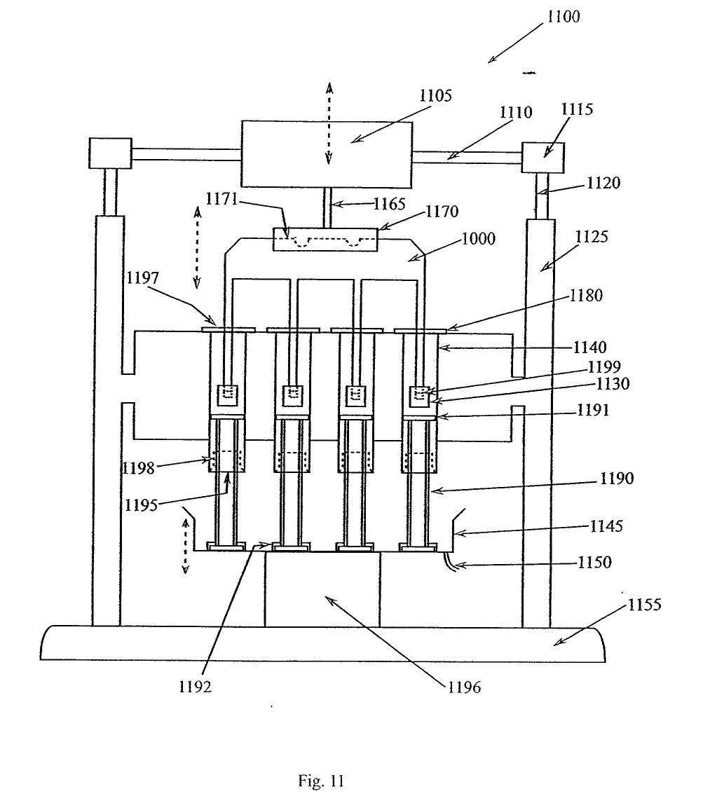

With reference to FIG. 10a, a hanger bracket 1000 is presented. Hanger bracket 1000 allows for the insertion of a substrate into a reaction chamber. More specifically, hanger bracket 1000 comprises top end 1020 having notch elements 1010 for connecting onto an agitation mechanism (not shown). Connected to top end 1020 are handle elements 1030. Handle elements 1030 comprise connection element 1050 for removably connecting substrates 1060 onto hanger bracket 1000. Connection element 1050 may be in any form readily known in the art such as, for example, a clamp, a clip, a hook, an adhesive device, a pin, a screw or suction device and is made of any suitable material known in the art, such as, for example, metals, such as aluminum, polymers or copolymers, such as plastic, polypropylene or polyethylene, or polycarbonate.

In a preferred embodiment, handle element 1030, hanger bracket top end 1020 and connection element 1050 are integrally molded into a single body. Further, hanger bracket 1000 is made of any suitable material known in the art, such as, for example, metals, such as aluminum, or polymers or copolymers, such as plastic, polypropylene and polyethylene. Preferably, hanger bracket 1000 is made of polypropylene.

A plurality of handle elements 1030 may extend from top 1020 of the hanger bracket 1000. The number of handle elements 1030 associated with a single hanger bracket 1000 can range from 1 to about 200, wherein the arrangement of a plurality of handle elements 1030 can be in any type of an array format conceivable by one skilled in the art. The spacing between adjacent handle means 1030 is defined by pitch 1040. In a preferred embodiment, pitch 1040 is between 0.1 to 5.0 inches, preferably the pitch is about 0.75 inches.

Many materials are suitable as substrate 1060. Preferably, substrate 1060 is or can be made hydrophilic, bibulous, and does not substantially bind nucleic acids irreversibly through either hydrophobic, ionic, covalent, or electrostatic means. Substrate 1060 must not by itself inhibit or bind amplification reactants, release substances that effect amplification reactants or otherwise affect PCR and other amplification reactions. Suitable materials for substrate 1060 include, but are not limited to, FTA, cellulosics, charged nylon membranes, woven porous polymers, or non-woven porous polymers, including polyesters, polypropylenes beads or combinations thereof. Further, substrate 1060 may be obtained commercially from a number of manufacturers such as Whatman and Schleicher & Schuell and is the subject of, for example, U.S. Pat. Nos. 5,939,259, 6,168,922, 6,020,186, WO 00/62023 and WO 00/66606, all of which are incorporated herein by reference.

In a preferred embodiment, substrate 1060 comprises reagents which lyse the biological source to expose the macromolecules contained therein. In this preferred embodiment, the reagents lyse blood cells, thereby exposing the DNA contained therein for removably binding substrate, for purification and for elution. Optionally, the lysing reagents may be added to the washing reagents.

The cells immobilized on or within the substrate are lysed preferably by physical or chemical action where lysis either may be effected mechanically, by shear forces, osmotic shock, or chemically using detergents or alkaline digestion. The cells may be lysed by lysing reagents either before, during or after application of the sample onto the substrate. Further, agitation may be provided by an agitation element to assist in lysis. The modes of agitation include, but are not being limited to, mechanical motion/vibration, ultrasonic, piezoelectric, magnetic, pulsating motion, vortex, pneumatic air or gas, hydraulic, aerating, encapsulated rotating magnets, rotating stirrers and paddles, orbital shakers or combinations thereof.

In a particularly preferred embodiment, the surface of the material forming the substrate has ion exchanging properties. Especially when using anion exchangers the nucleic acid emerging from the lysed cell may be bound removably to the material forming the substrate to be eluted by adjusting to high ionic strengths subsequent to various washing operations.

The shape or configuration of substrate 1060 can vary. One can choose from, for example, flat sheets, such as rectangles, or circular shapes, such as circles as shown in FIG. 1a, three dimensional forms such as non-magnetizable beads, multilayer membranes, or magnetic microparticle beads.

Other reagents can be added to the present invention in order to enhance lysis or disruption of intact cells, bacteria or viruses absorbed onto the substrate. For example, suitable anionic, cationic, or zwitterionic surfactants, such as Tween 20 or Triton X-100, can be impregnated onto the substrate.

FIG. 10b represents a side, cross-sectional view of the elements in FIG. 10a.

With reference to FIG. 11, reaction station 1100 is presented. Preferably, said reaction station 1100 is a washing reaction station. Reaction station 1100 comprises reaction chambers 1140 mounted on reaction chamber holding element 1125. Reaction chamber holding element 1125, in turn, is mounted upon base 1155. Reaction chambers 1140 are substantially hollow and comprise top opening 1197, capable of receiving substrate 1130, bottom opening 1195, capable of receiving valve element 1191 affixed onto the top end of plunger 1190, aperture element 1198, capable of being maintained in an open or closed state by said valve element 1191, and suspending element 1180, for reversibly engaging the reaction chamber 1140 to said reaction chamber holder 1125. In the open state of said aperture 1198, the contents of the reaction chamber 1140 are allowed to be released solely by gravity. In the closed state of said aperture 1198, the contents of the reaction chamber 1140 are retained in said reaction chamber 1140. Substrate 1130 is connected onto hanger bracket 1000 by connection element 1150. The bottom end of plunger elements 1190 is mounted to collection container 1145 by virtue of plunger connection elements 1192. Collection container 1145, in turn, is mounted on movable collection container connection element 1196, said collection container connection element 1196 is mounted onto base 1155. Collection container 1145 also comprises drain outlet 1150.

Hanger bracket 1000 is connected to bracket mount 1170 which, in turn, is connected to agitation mechanism 1105 by hanger bracket connection element 1165. Agitation mechanism 1105 is adapted to move hanger bracket 1000 in an up and down motion, thereby allowing for the insertion and removal of substrates 1130 from reaction chambers 1140. Agitation mechanism 1105 is attached to track element 1115 by virtue of holder element 1110. Track element 1115 is adapted to move agitation mechanism 1105 and hanger bracket 1000 in a horizontal direction in order to position substrates 1130 above top openings 1197 of reaction chambers 1140. Track element 1115 is attached onto reaction chamber holding element 1125 by connection element 1120.

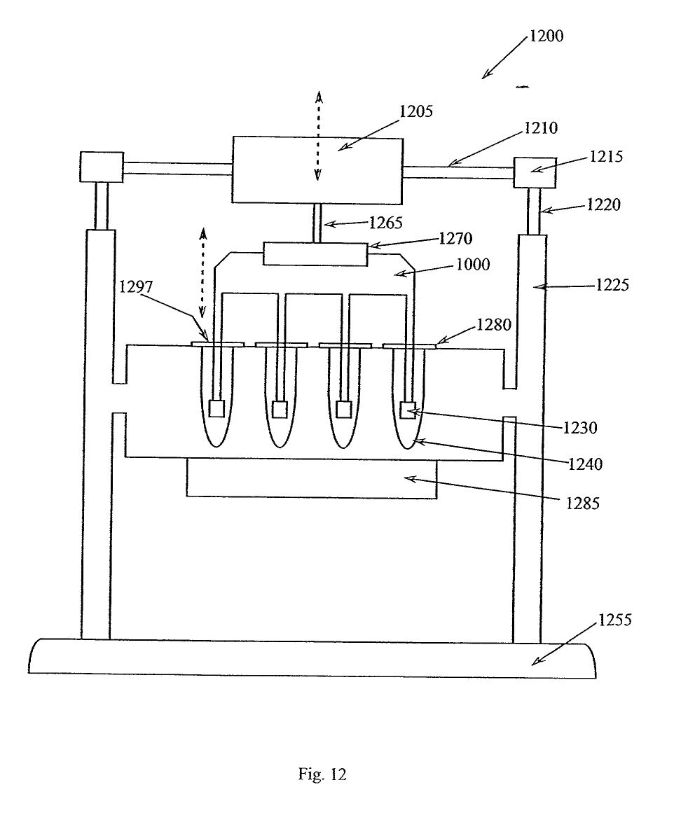

With reference to FIG. 12, a preferred embodiment of reaction station 1200 is presented. Preferably, reaction station 1200 is an elution reaction station. Reaction station 1200 comprises reaction chambers 1240 mounted on reaction chamber holding element 1225. Reaction chamber holding element 1225, in turn, is mounted upon base 1255. Reaction chambers 1240 are substantially hollow, sealed at one end and comprises top opening 1297, capable of receiving substrate 1230. Substrate 1230 is connected onto hanger bracket 1000. The sealed ends of reaction chambers 1240 are in close proximity to heating element 1285.

Hanger bracket 1000 is connected to bracket mount 1270 which, in turn, is connected to agitation mechanism 1205 by hanger bracket connection element 1265. Agitation mechanism 1205 is adapted to move hanger bracket 1000 in an up and down motion, thereby allowing for the insertion and removal of substrates 1230 from reaction chambers 1240. Agitation mechanism 1205 is attached to track element 1215 by virtue of holder element 1210. Track element 1215 is adapted to move agitation mechanism 1205 and hanger bracket 1000 in a horizontal direction in order to position substrates 1230 above the top openings 1297 of reaction chambers 1240. Track element 1215 is attached onto reaction chamber holding element 1225 by connection element 1220.

In a preferred embodiment, an identification element is provided for identifying the substrate. In a most preferred embodiment, the lollypads of the present invention have an identification element for identifying the lollypad. Preferably, the identification element is a barcode, but a skilled artisan would readily understand that other identifying elements are possible such as, for example, a label.

In a preferred embodiment, the process of purifying nucleic acids from a blood sample involves dispensing an aliquot of blood using the dispensing means onto a substrate, such as FTA paper or the like, at a dispensing station. The substrate has lysing reagents which lyse the wall of the blood cells thereby exposing the cellular nucleic acid to the substrate. The lysing reagents may be included in the substrate as purchased from the manufacturer, or may be applied upon use. It is also contemplated that the lysing reagents are not added to the substrate itself, but into the reaction chamber prior to or during immersion of the substrate in the chamber. Most preferably, the process is automated.

In use, the substrate is held in place by the holding means which is attached to a carrying means. The carrying means is attached to a transfer apparatus that transfers the substrate from the sample dispensing station to the reaction station. The transfer apparatus is made of any suitable material known in the art such as, for example, metals, such as aluminum, polymers or copolymers, such as plastic, polypropylene. Preferably, the transfer apparatus is robotic.

The reaction station contains at least one washing station. At the washing station, the transfer apparatus vertically inserts the substrate into the hollow chamber. The substrate is optionally dried by an air conduit. The platform moves upward to engage the plunger element into the aperture on the bottom of chamber. The sealing means, made of any material known in the art such as, for example, rubber, silicone or a polymer blend, assists in aligning the plunger element to the aperture.

Upon engagement of the valve to the aperture of the chamber, washing reagents are dispensed by the reagent conduit onto the substrate and collected by the chamber. The chamber is agitated by either mechanical, piezoelectric or ultrasonic means.

The valve is used to provide for gravitational flow or drainage from the chambers. The valve may be made of any material or design known in the art. The materials used for the valve include, for example, silicone, rubber, TPE, TPR or the like. Preferably, the valve is made of silicone. Further, the design of the valve may be of the plunger type, a flexible pad to provide a flat surface seal to the aperture of the chamber, a rotary type such as a those used in a burette, a ball valve, a slice valve, a slide valve, a needle valve or combinations thereof. The valve may be disposable or reusable.

After washing, the platform moves downward to disengage the valve on the plunger element from the aperture, thereby allowing the washing reagents to be dispensed by gravity to the collection container for subsequent disposal. If further washing is needed, the transfer apparatus transfers the substrate to a second washing station and the process is repeated. In a preferred embodiment, there is a plurality of washing steps, preferably from three to five washing steps, all utilizing gravity.

Upon completion of washing, the transfer apparatus transfers the substrate to the elution station. At the elution station, the transfer apparatus vertically inserts the substrate into the hollow chamber. Elution reagents are gravitationally dispensed by the reagent conduit onto the substrate and collected by the chamber. About 5 μl to about 1000 μl, preferably from about 50 to about 100 μl, of pre-warmed elution reagents are introduce, such as, for example, tris-HCl-EDTA (TE) or water. A cover is placed upon the chamber and removably sealed with sealing means. The substrate is allowed to come into contact with the elution reagents for about 10 to about 15 minutes, preferably while being heated by the heating block. Preferably, the chamber or rod or both are agitated by means readily known in the art such as, for example, mechanical, piezoelectric, ultrasonic, magnetic or electromagnetic means. Such means assist in elution.

After elution, the substrate is removed from the elution chamber. If further elution is needed, the transfer apparatus transfers the substrate to a second elution station and the process is repeated.

It is contemplated that the substance to be, for example, purified or isolated from the sample comprising said substance is, for example, chemical, biological, inorganic or organic. It is further contemplated that the source of the sample may be chemical or biological, but is not restricted to, blood, cells, sub-cellular preparations, bacterial culture, bacterial colonies, virus-containing preparations, saliva, urine, drinking water, plasma, stool samples and sputum.

It is also contemplated that the substrate of the present invention may be any substrate known in the art. Preferred substrates include, but are not limited to, treated membranes, untreated membranes, cellulose nitrate, cellulose acetate, surfactant-free cellulose acetate (SFCA), nylon, polyvinylidene fluoride (PVDF), polyether sulfone (PES), glass fiber/frit filter, electrically charged substrates with corona, beads, particles, silica, glass, plastics, clays, ceramics, resins, fibers, fabrics or combinations thereof.

In a particularly preferred embodiment, the substrate may be a microparticle bead, a bead coated with oligonucleotide probes, antibody-coated beads, strepavidin-coated beads, protein-coated beads, beads coated with intercalating dyes, or combinations thereof. Such beads may be obtained from Dynal, Inc. Preferably, the beads mentioned above, or combinations thereof, are placed in a holding sack for insertion into the reaction chamber. The holding sack is a textile-like material made of any material known to a skilled artisan such as, for example, natural or synthetic materials. Preferably, the holding sack is made from dialysis materials and mesh materials. Dialysis materials, such as dialysis tubing, are obtained from Spectrum Laboratories (Rancho Dominguez, Calif.), Pierce Chemical Company (Rockford, Ill.) and Bio-Rad Laboratories (Hercules, Calif.). Mesh material are obtained from American Home & Habitat (Spotsylvania, Va.), Newark Wire Cloth Company (Verona, N.J.) and TWP Inc. (Berkeley, Calif.).

The biological target material isolated using the methods of the present invention is preferably a nucleic acid or a protein, more preferably a nucleic acid material such as RNA, DNA, a RNA/DNA hybrid, or a DNA/protein complex. When the biological target material isolated using the present methods is a nucleic acid, it is preferably DNA, or RNA including but not limited to plasmid DNA, DNA fragments produced from restriction enzyme digestion, amplified DNA produced by an amplification reaction such as PCR, single-stranded DNA, mRNA, or total RNA. The nucleic acid material isolated according to the methods of the present invention is even more preferably a plasmid DNA or total RNA.

Since nucleic acids are the most preferred biological target material isolated using the methods of the present invention, most of the detailed description of the invention below describes this preferred aspect of the present invention. However, the detailed description of this particular aspect of the present invention is not intended to limit the scope of the invention. The present disclosure provides sufficient guidance to enable one of ordinary skill in the art of the present invention to use the methods of the present invention to isolate biological target materials other than nucleic acid materials, e.g., proteins or antibodies or isolate chemical substances from samples comprising said substances.

The present methods of isolating biological target material can be practiced using any silica magnetic particle, but the methods are preferably practiced using the siliceous-oxide coated magnetic (SOCM) particles. The present methods are also preferably practiced using silica magnetic particles with the following physical characteristics.

The silica magnetic particles used in the methods of this invention may be any one of a number of different sizes. Smaller silica magnetic particles provide more surface area (one per weight unit basis) for adsorption, but smaller particles are limited in the amount of magnetic or paramagnetic material which can be incorporated into such particles compared to larger particles. The median particle size of the silica magnetic particles used in the present invention is preferably about 1 to about 15 μm, more preferably from about 3 to about 10 μm, and most preferably from about 4 to about 7 μm. The particle size distribution may also be varied. However, a relatively narrow monodal particle size distribution is preferred. The monodal particle size distribution is preferably such that about 80% by weight of the particles are within an about 10 μm range about the median particle size, more preferably within an about 8 μm range, and most preferably within an about 6 μm range.

The silica magnetic particle preferably used in the present invention has pores which are accessible from the exterior of the particle. The pores are preferably of a controlled size range sufficiently large to admit a biological target material, e.g., nucleic acid, into the interior of the particle and to bind to the silica gel material on the interior surface of most such pores. The pores of the most preferred form of the silica magnetic particles are designed to provide a large surface area of silica gel material capable of binding a biological target material, particularly nucleic material. The total pore volume of a silica magnetic particle, as measured by nitrogen BET method, is preferably at least about 0.2 ml/g of particle mass. Of the total pore volume measured by nitrogen BET, preferably at least about 50% of the pore volume is contained in pores having a diameter of 600 A or greater.

The silica magnetic particles may contain substances, such as transition metals or volatile organics, which could adversely affect the utility of isolated biological target material substantially contaminated with such substances. Specifically, such contaminants could affect downstream processing, analysis, and/or use of the such materials, for example, by inhibiting enzyme activity or nicking or degrading the target material itself. Any such substances present in the silica magnetic particles used in the present invention are preferably present in a form which does not readily leach out of the particle, and into the isolated biological target material produced according to the methods of the present invention. Iron is one such undesirable contaminant, particularly when the biological target material is a nucleic acid. Iron, in the form of magnetite, is present at the core of a particularly preferred form of the silica magnetic particles of the present invention, i.e. the SOCM particles. Iron has a broad absorption peak between about 260 and about 270 nanometers (nm). Nucleic acids have a peak absorption at about 260 nm, so iron contamination in a nucleic acid sample can adversely affect the accuracy of the results of quantitative spectrophotometric analysis of such samples. Any iron containing silica magnetic particles used to isolate nucleic acids using the present invention preferably do not produce isolated nucleic acid material sufficiently contaminated with iron for the iron to interfere with spectrophotometric analysis of the material at or around 260 nm.

The most preferred silica magnetic particles used in the methods of the present invention, the SOCM particles, leach no more than about 50 ppm, more preferably no more than about 10 ppm, and most preferably no more than about 5 ppm of transition metals when assayed as follows. Specifically, 0.33 g of the particles (oven dried at about 110° C.) into 20 ml. of 1N HCl aqueous solution (using deionized water). The resulting mixture is then agitated only to disperse the particles. After about 15 minutes total contact time, a portion of the liquid from the mixture is then analyzed for metals content. Any conventional elemental analysis technique may be employed to quantify the amount of transition metal in the resulting liquid, but inductively coupled plasma spectroscopy (ICP) is preferred.

Methods for producing SOCM particles are known in the art. The most preferred such method for producing SOCM particles for use in the present invention comprises the general steps of: (1) preparing magnetite core particles by aqueous precipitation of a mixture of FeCl₂ and FeCl₃. (2) depositing a siliceous oxide coating on the magnetite core particles by exposing a slurry of the particles to a mixture of SiO₂ and Na₂O for at least about 45 minutes at a temperature of at least about 60° C. and then adding an acid solution to the mixture until the pH is lowered to a pH less than 9, (3) allowing the resulting slurry to age for at least about 15 minutes, preferably while continuing to agitate the slurry, and (4) washing the particles. The deposition and aging steps of the preferred particle production method described above can be repeated to produce multiple layers of siliceous oxide coating over the magnetite core, thus providing additional insurance against leaching of metals from the core into the surrounding environment. SOCM particles produced by the method described above are most preferably treated by being subjected to a mild oxidizing step to further inhibit leaching from the core.

The biological target material isolated using the method of the present invention can be obtained from eukaryotic or prokaryotic cells in culture or from cells taken or obtained from tissues, multicellular organisms including animals and plants; body fluids such as blood, lymph, urine, feces, or semen; embryos or fetuses; food stuffs; cosmetics; or any other source of cells. Some biological target materials, such as certain species of DNA or RNA are isolated according to the present method from the DNA or RNA of organelles, viruses, phages, plasmids, viroids or the like that infect cells. Cells will be lysed and the lysate usually processed in various ways familiar to those in the art to obtain an aqueous solution of DNA or RNA, to which the separation or isolation methods of the invention are applied. The DNA or RNA, in such a solution, will typically be found with other components, such as proteins, RNAs (in the case of DNA separation), DNAs (in the case of RNA separation), or other types of components.

Regardless of the nature of the source of such material, the biological target material to be isolated in the present methods is provided in a medium comprising the biological target material and other species. The biological target material must be present in the medium in a form in which it is available to adhere to the silica magnetic particles in the first step of the method. When the nucleic acid material is contained inside a cell, the cell walls or cell membrane can make the material unavailable for adhesion to the particles. Even if such cells are lysed or sufficiently disrupted to cause the nucleic acid material contained therein to be released into the surrounding solution, cellular debris in the solution could interfere with the adhesion of the nucleic acid material to the silica magnetic particles. Therefore, in cases where the nucleic acid material to be isolated using the methods of the present invention is contained within a cell, the cell is preferably first processed by lysing or disrupting the cell to produce a lysate, and more preferably additionally processed by clearing the lysate of cellular debris through sequential washing in the washing station.

Any one of a number of different known methods for lysing or, disrupting cells to release nucleic acid materials contained therein are suitable for use in producing a medium from cells for use in the present invention. The method chosen to release the nucleic acid material from a cell will depend upon the nature of the cell containing the material. For example, nucleic acid material can be readily released from cells with lipid bi-layer membranes such as E. coli bacteria or animal blood cells merely by suspending such cells in an aqueous solution and adding a detergent to the solution.

In a particularly preferred aspect of the present method, the nucleic acid material of interest isolated according to the method of the present invention is plasmid DNA initially contained in an E. coli bacteria cell. The nucleic acid material is most preferably released from the bacteria cell by addition of an alkaline solution, such as a solution of sodium hydroxide, to form a lysate. A neutralizing solution, such as an acidic buffer, is preferably added to the resulting supernatant to form a precipitate of additional potentially interfering material. The precipitate thus formed is preferably removed by centrifugation. The remaining supernatant of cleared lysate is the medium provided in the first step of this particularly preferred aspect of the present method.

The medium provided in the first step of the method of this invention need not contain nucleic acid material released directly from cells. The nucleic acid material can be the product of an amplification reaction, such as amplified DNA produced using the polymerase chain reaction. The nucleic acid material can also be in the form of fragments of DNA produced by digesting DNA with a restriction enzyme. The medium can also be in the form of a mixture of melted or enzymatically digested electrophoresis gel and nucleic acid material.

The silica magnetic particles provided in the second step of the methods of the present invention preferably have the capacity to form a complex with the nucleic acid material in the medium by removably binding at least about 2 micrograms of nucleic acid material per milligram of particle. The particles provided for use in the present invention more preferably have the capacity to removably bind at least about 4 micrograms, and more preferably at least about 8 micrograms of nucleic acid material per milligram of particle. The silica magnetic particles should preferably have the capacity to release at least about 60% of the nucleic acid material adhered thereto. The particles more preferably have the capacity to release at least about 70%, and most preferably at least about 90% of the nucleic acid material adhered thereto. The silica magnetic particles provided in the first step of the methods of the present invention are most preferably SOCM particles.

A complex of the silica magnetic particles and the biological target material is formed in the third step, preferably by exposing the particles to the medium containing the target material under conditions designed to promote the formation of the complex. The complex is more preferably formed in a mixture of the silica magnetic particle, the medium, and a chaotropic salt.

Chaotropic salts are salts of chaotropic ions. Such salts are highly soluble in aqueous solutions. The chaotropic ions provided by such salts, at sufficiently high concentration in aqueous solutions of proteins or nucleic acids, cause proteins to unfold, nucleic acids to lose secondary structure or, in the case of double-stranded nucleic acids, melt (i.e., strand-separate). It is thought that chaotropic ions have these effects because they disrupt hydrogen-bonding networks that exists in liquid water and thereby make denatured proteins and nucleic acids thermodynamically more stable than their correctly folded or structured counterparts. Chaotropic ions include guanidinium, iodide, perchlorate and trichloroacetate. Preferred in the present invention is the guanidinium ion. Chaotropic salts include guanidine hydrochloride, guanidine thiocyanate (which is sometimes referred to as guanidine isothiocyanate), sodium iodide, sodium perchlorate, and sodium trichloroacetate. Preferred are the guanidinium salts, and particularly preferred is guanidine hydrochloride.

The concentration of chaotropic ions in the mixture formed in this practice of the present method is preferably between about 0.1 M and about 7 M, but more preferably between about 0.5 M and about 5 M. The concentration of chaotropic ions in the mixture must be sufficiently high to cause the biological target material to adhere to the silica magnetic particles in the mixture, but not so high as to substantially denature, to degrade, or to cause the target material to precipitate out of the mixture. Proteins and large molecules of double-stranded DNA, such as chromosomal DNA, are stable at chaotropic salt concentrations between about 0.5 and about 2 molar, but are known to precipitate out of solution at chaotropic salt concentrations above about 2 molar. See, e.g. U.S. Pat. No. 5,346,994, column 2, lines 56-63. Contrastingly, RNA and smaller molecules of DNA such as plasmid DNA, restriction or PCR fragments of chromosomal DNA, or single-stranded DNA remain undegraded and in solution at chaotropic salt concentrations between about 2 and about 5 molar.

With any chaotropic salt used in the invention, it is desirable that the concentration of the salt, in any of the solutions in which the salt is employed in carrying out the invention, remain below the solubility of the salt in the solution under all of the conditions to which the solution is subjected in carrying out the invention.

In a practice of the present methods, the mixture formed as described above is incubated until at least some of the nucleic acid material is adhered to the silica magnetic particle to form a complex. This incubation step is carried out at a temperature of at least about 0° C., preferably at least about 4° C., and more preferably at least about 20° C., provided that the incubation temperature is no more than about 67° C. The incubation step must be carried out at a temperature below the temperature at which the silica magnetic particles begin to loose their capacity to removably bind the nucleic acid material. The incubation step is most preferably carried out at about room temperature (i.e., at about 25° C.).

The complex is removed from the mixture using a magnetic field. Other forms of external force in addition to the magnetic field can also be used to isolate the biological target substance according to the methods of the present invention after the initial removal step. Suitable additional forms of external force include, but are not limited to, gravity filtration.

The external magnetic field used to remove the complex from the medium can be suitably generated in the medium using any one of a number of different known means. For example, one can position a magnet on the outer surface of a container of a solution containing the particles, causing the particles to migrate through the solution and collect on the inner surface of the container adjacent to the magnet. The magnet can then be held in position on the outer surface of the container such that the particles are held in the container by the magnetic field generated by the magnet, while the solution is decanted or drained out of the container and discarded. A second solution can then be added to the container, and the magnet removed so that the particles migrate into the second solution. Alternatively, a magnetizable probe could be inserted into the solution and the probe magnetized, such that the particles deposit on the end of the probe immersed in the solution. The probe could then be removed from the solution, while remaining magnetized, immersed into a second solution, and the magnetic field discontinued permitting the particles go into the second solution. Commercial sources exist for magnets designed to be used in both types of magnetic removal and transfer techniques described in general terms above. See, e.g. MagneSphere® Technology Magnetic Separation Stand or the PolyATract® Series 960OTM Multi-Magnet, both available from Promega Corporation; Magnetight Separation Stand (Novagen, Madison, Wis.); or Dynal Magnetic Particle Concentrator (Dynal, Oslo, Norway).

In a preferred aspect of the methods of the present invention, the complex removed from the medium in the third step is washed at least once by being rinsed in a washing reagent or solution. The washing reagent or solution may be aqueous or non-aqueous. Preferably, the washing reagent or solution is aqueous. The wash solution used in this preferred additional step of the method preferably comprises a solution capable of removing contaminants from the silica magnetic particle. The wash solution preferably comprises a salt and a solvent, preferably an alcohol. The concentration of alcohol in this last preferred form of the wash solution is preferably at least about 30% by volume, more preferably at least about 40% by volume, and most preferably at least about 50% by volume. The alcohol so used is preferably ethanol or isopropanol, more preferably ethanol. The salt is preferably in the form of a buffer, and most preferably in the form of an acetate buffer. The concentration of salt in the wash solution is sufficiently high to ensure the nucleic acid material is not eluted from the silica magnetic particles during the wash step(s).

The complex is preferably washed after removal from the medium by resuspending the complex in the wash solution. The complex is preferably removed from the wash solution after the first wash, and washed at least once more, and most preferably three more times using fresh wash solution for every wash step.

Fourth, and finally, the nucleic acid material is eluted from the silica magnetic particle by exposing the complex to an elution solution. The elution solution may be aqueous or nonaqueous. Preferably, the elution solution is an aqueous solution of low ionic strength, more preferably water or a low ionic strength buffer at about a pH at which the nucleic acid material is stable and substantially intact. Any aqueous solution with an ionic strength at or lower than TE buffer (i.e. 10 mM Tris-HCl, 1 mM EDTA, pH 8.0) is suitable for use in the elution steps of the present methods, but the elution solution is preferable buffered to a pH between about 6.5 and about 8.5, and more preferably buffered to a pH between about 7.0 and about 8.0. TE Buffer and distilled or deionized water are particularly preferred elution solutions for use in the present invention. The low ionic strength of the preferred forms of the elution solution described above ensures the nucleic acid material is released from the particle. Other elution solutions suitable for use in the methods of this invention will be readily apparent to one skilled in this art.

In a preferred embodiment, and when magnetic beads or microparticles are used as a substrate, the magnetic beads or microparticles may be transferred from the washing station to the elution station by using a magnetic or magnetizable probe. The probe is made of, for example, and without limitation, a plastic sheath substantially surrounding a magnetic or magnetizable core material. The plastic sheath may be reusable or disposable and may be made of any known material in the art, such as, for example, polyethylene or polypropylene. Preferably, if the plastic sheath is reusable, it should also be sterilizable. The core material may be a magnet, such as for example, a needle magnet. The core material may also be made of any magnetic or magnetizable material known in the art, including, for example, iron, ferric oxide and the like. The probe may optionally contain a coil surrounding the core. In use, the probe is inserted into the washing chamber and a voltage is applied to the probe, thereby attracting the magnetic beads or microparticles which affix onto the probe. With the voltage still on, the probe is removed from the washing chamber and placed into the elution chamber. A variable electric charge and a reversing switch for applying an opposite field is established in order to demagnetize the magnetic field. The magnetic beads or microparticles are thereby detached from the probe due to the hysteresis effect.

The nucleic acid material eluted from the complex in the elution step of the method is preferably separated from the silica magnetic particles and complexes remaining in the elution mixture by external force, such as centrifugation or a magnetic field, but more preferably using centrifugation. Centrifugation is preferred because it can result in the removal of particles or particle fragments which are too small or which are not sufficiently magnetically responsive to be removed by using a magnetic field.

The nucleic acid material eluted using the method of the present invention is suitable, without further isolation, for analysis or further processing by molecular biological procedures. The eluted nucleic acid can be analyzed by, for example, sequencing, restriction analysis, or nucleic acid probe hybridization. Thus, the methods of the invention can be applied as part of methods, based on analysis of DNA or RNA, for, among other things, diagnosing diseases; identifying pathogens; testing foods, cosmetics, blood or blood products, or other products for contamination by pathogens; forensic testing; paternity testing; and sex identification of fetuses or embryos.

The eluted DNA or RNA provided by the method of the invention can be processed by any of various exonucleases, endonucleases or nucleic acid modification enzymes that catalyze reactions with DNA or RNA, respectively, and, in the case of DNA, can be digested with restriction enzymes, which cut at restriction sites present in the DNA. Restriction fragments from the eluted DNA can be ligated into vectors and transformed into suitable hosts for cloning or expression. Segments of the eluted DNA or RNA can be amplified by any of the various methods known in the art for amplifying target nucleic acid segments. If eluted DNA is a plasmid or another type of autonomously replicating DNA, it can be transformed into a suitable host for cloning or for expression of genes on the DNA which are capable of being expressed in the transformed host. Plasmid DNAs isolated by methods of the present invention have been found to be more efficiently transfected into eukaryotic cells than those isolated by the prior art method, wherein diatomaceous earth is employed in place of the silica gel in the methods of the invention of this application.

### DETAILED EXAMPLES

The following examples are set forth to illustrate examples of embodiments in accordance with the invention, it is by no way limiting nor do these examples impose a limitation on the present invention.

### Example 1

### Sample Dispense

A pipette was used to transfer a 200 microliter aliquot of human blood from a vacuum collection tube onto the surface of a FTA (Whatman) substrate having a lysing agent, such as a surfactant. To evenly disperse the blood sample across the surface of the substrate the aliquot was dispensed as the substrate was in a horizontal position. Upon contact with FTA substrate, cellular lysis occurred and the released nucleic acids removably bound to substrate.

### Example 2

### Washing Station

The FTA substrate containing the blood sample was robotically transferred to the washing station. The carrying rod, attached to the frame and handle of the FTA substrate, was robotically moved and rotated such that the FTA substrate was in a substantially vertical position in the hollow chamber. The hollow chamber was held in place on the holder that was, in turn, attached to the platform. Beneath the hollow chamber was positioned the collection container in which the plunger with the valve thereon was directed upwards such that the valve was positioned in the aperture at the base of the hollow chamber, thus preventing fluid flow out through the hollow chamber. The FTA substrate was placed into the hollow chamber such that the FTA substrate substantially avoided contact with the walls of the hollow chamber. A solution of 0.5% SDS was added in an automated fashion to the hollow chamber via an automated reagent delivery apparatus such that the FTA substrate became submerged. The contents of the chamber were agitated at room temperature for 5 minutes. The platform moved the plunger and valve away from the base of the hollow chamber, thereby allowing the washing solution to be drained and collected in the collection container. After drainage, the plunger and valve were repositioned to block movement of fluids through the aperture. The washing steps were repeated as above, preferably three times.

### Example 3

### Elution Station

The washed FTA substrate from Example 2 was robotically moved from the washing station to a hollow elution chamber housed in the heating block. The FTA substrate was vertically inserted in the hollow elution chamber and was pressed up against the walls of the hollow elution chambers. To elute the nucleic acids, a small volume of Tris-HCl 10 mM, EDTA 1 mM was added to the hollow elution chamber such that the FTA substrate was substantially emersed. The hollow elution chamber was heated to 85° C. for 10 minutes to elute the nucleic acids. The FTA substrate was robotically removed from the hollow elution chamber.

### Example 4

### Purification of Nucleic Acids Using Magnetic Beads

Magnetic microparticles were used in connection with the instant invention to isolate and purify DNA from a 400 μl sample of blood. The collection container was positioned below the hollow chamber of the washing station, such that the valve was positioned in the aperture at the base of the hollow chamber. The sample of blood was combined with an equal volume of magnetic bead resin, which contained the lysis buffer (0.5% SDS), and placed into the hollow chamber of the washing station. The sample was mixed for one minute at room temperature. A magnetic field was applied to the side of the hollow chamber, thereby removably fixing the magnetic beads to the side of the hollow chamber. The plunger and valve were moved away from the base of the hollow chamber, thereby allowing the solution to be drained and collected in the collection container. After drainage, the plunger and valve were repositioned to block movement of fluids through the aperture and the magnet of the instant invention was released, thereby releasing the magnetic beads from the inner wall of the hollow chamber. A 600 μl aliquot of lysis buffer was added to the hollow chamber and mixed by agitation of the instant invention for 1 minute. The magnet of the instant invention was reapplied so that the lysis buffer could be drained through the aperture of the hollow chamber as before. The aperture was re-closed by the plunger, the magnet was again released, and an aliquot of 800 μl of wash solution (70% ethanol) was added to the hollow chamber. The sample was mixed and agitated for approximately 1 minute. The magnet was again applied and the wash solution was drained through the aperture of the hollow chamber as before. The wash cycle was repeated two additional times.

A magnetic probe was inserted into the washing chamber to collect the magnetic microparticles. A voltage was applied to the probe. The microparticles became affixed onto the probe. The probe and the microparticles were removed from the washing chamber to the elution chamber. The probe was demagnetized and the microparticles were disengaged from the probe. The probe was removed from the elution chamber.

To elute the nucleic acids from the magnetic bead substrate, a small volume of elution solution (Tris-HCl, 10 mM, EDTA, 1 mM) was added to the hollow chamber, mixed and agitated as before. The magnet was applied as before and the eluted nucleic acid was drained as the same manner as before into a clean collection container through the aperture of the hollow chamber.

### Example 5

### Purification of Nucleic Acids Using Nylon Substrate

Nylon substrate (Biodyne A, Pall Corporation) was cut into 0.2×0.8 inch strips and attached to the hanger bracket. The hanger bracket was attached to an agitation device. 20 μl of Proteinase K (Sigma) (20 mg/ml) was pipetted into a 1.5 ml microcentrifuge tube. 200 μl of whole blood and 350 μl of a solution containing ammonium chloride, cetyltrimethylammonium bromide, and polyvinylpyrrolidinone was added and vortexed for 5 seconds. The solution was incubated in a thermomixer (Eppendorf) 70° C., 900 rpm for 10 minutes. 200 μl of a solution containing isopropanol, NP40, was added to the tube. The blood lysate mixture was vortexed for 5 seconds. The blood lysate mixture was transferred into the reaction chamber with a valve and plunger sealing the bottom opening. The nylon substrate was inserted into the reaction chamber and allowed to soak and shake gently inside the reaction chamber for approximately 30 minutes. The plunger was pulled down and the blood lysate mixture was allowed to gravitationally drain. The plunger was pushed back up into reaction chamber. 800 μl of washing solution containing Tris-HCl, EDTA and NaCl was pipetted into the reaction chamber. The nylon substrate was subjected to vigorous agitation for 2 minutes. The plunger was pulled down again, the waste was released and the plunger was pushed back up to seal the bottom of the reaction chamber. The washing step was repeated. The nylon substrate was removed from the reaction chamber and air dried for 5 minutes, and then transferred to the elution reaction chamber containing 200 μl elution buffer. The nylon substrate was incubated for 3 minutes at 70° C. in the elution reaction chamber. The hanger bracket with the nylon substrate was removed from the elution reaction chamber and the nucleic acids attached to the nylon substrate were amplified using PCR.

### Example 6

### Analysis of Purified Nucleic Acids

Upon removal of the nucleic acids from the substrate in previous Examples, the nucleic acids were amplified using PCR with two sets of primers targeting two locations on human beta-hemoglobin gene 900 bp and 7.5 kb. This demonstrated the integrity of the genomic DNA. OilGreen and PicoGreen fluorescent dyes were used to identify the single strand and double strand DNA and to quantify the amount of DNA. UV 260/280 absorption was also used to characterize the purity of the DNA. FIG. 9 shows the results of field inversion gel electrophoresis.

Although preferred embodiments of the present invention and modifications thereof have been described in detail herein, it is to be understood that this invention is not limited to that other modifications and variations parting from the spirit and scope of the

What is claimed is:

1. A device to treat a biological sample, comprising a reaction chamber with top and bottom ends, said reaction chamber adapted to receive a substrate and a fluid, said substrate adapted to receive the biological sample and adapted to be in contact with the fluid when the fluid is in the reaction chamber, said reaction chamber having an aperture, positioned substantially at the bottom end of the reaction chamber, that is selectively opened or closed such that in the closed position the reaction chamber retains the fluid and in the opened position the reaction chamber allows the fluid to leave the reaction chamber solely by gravity.

2. The device according to claim 1, wherein said device comprises a washing station and an elution station, wherein said washing station and elution station comprise a reaction chamber according to claim 1.

3. The device according to claim 2, wherein the biological sample is applied to the substrate in the washing station by contacting the substrate with the fluid, wherein said fluid comprises the biological sample.

4. The device according to claim 1, wherein the substrate comprises the biological sample.

5. The device according to claim 1, wherein said fluid is agitated when the substrate is in contact with the fluid.

6. The device according to claim 1, wherein the reaction chamber comprises a heating element.

7. The device according to claim 1, wherein the reaction chamber comprises an agitation element.

8. The device according to claim 1, wherein the reaction chamber comprises a transfer element.

9. The device according to claim 1, wherein the substrate is on a holder.

10. The device according to claim 1, wherein the biological sample comprises blood, lymph, animal tissue, plant tissue, cells, sub-cellular preparations, bacterial culture, bacterial colonies, virus-containing preparations, saliva, urine, drinking water, plasma, feces, sputum, semen, embryo/fetal tissue or a mixture of any of the foregoing.

11. The device according to claim 1, wherein the substrate is selected from the group consisting of treated membranes, untreated membranes, cellulosics, cellulose nitrate, cellulose acetate, nylon, glass fiber, electrically charged substrates such as corona, beads, silica, glass, plastics, clays, ceramics, resins, fibers, fabrics, microparticle beads, nanotubes, beads coated with oligonucleotide probes, antibody-coated beads, strepavidin-coated beads, protein-coated beads, beads coated with intercalating dyes, woven porous polymers, non-woven porous polymers, polyesters, polyolefins, and combinations thereof.

12. The device according to claim 1, wherein the fluid comprises a washing reagent or an elution reagent.

13. The device according to claim 1, wherein the fluid is aqueous.

14. The device according to claim 12, wherein said washing reagent or said elution reagent is, separately or together, a buffer, surfactant, water, organics or alcohol.

15. The device according to claim 12, wherein said washing reagent comprises a lysing compound.

16. The device according to claim 1, wherein the substrate is adapted to receive a lysing compound.

17. A method for purifying or isolating a substance from a biological sample utilizing gravitational flow, said method comprising contacting the substance with a substrate and treating the substrate in the device according to claim 1, whereby the sample is contacted onto the substrate before or while the substrate is inside the reaction chamber.

18. An apparatus for purifying or isolating one or more substances from a sample comprising said one or more substances, comprising:
a) at least one gravity flow washing station comprising:
i) a reaction chamber comprising:
1) a hollow chamber for receiving said sample, said chamber comprising inner and outer walls and a top end with an orifice and a bottom end with an aperture;
2) an inlet for dispensing at least one washing reagent; and
3) an outlet for draining said washing reagent; and
ii) a movable reaction chamber holding means removably engaged to said reaction chamber; and
iii) a collection container for receiving the washing reagents on a movable base,
wherein said collection container comprises a top with an opening, sides and bottom wherein a plunger is affixed to the bottom of the collection container, and the reaction chamber passes through the opening on the top of the collection container and comes into contact with the plunger, and said base and said reaction chamber holder move, independent of each other or together, horizontally, vertically or diagonally, or combinations thereof; and
b) at least one gravity flow elution station comprising:
a reaction chamber comprising:
1) a hollow chamber housed in an elution heating block, said hollow chamber comprising inner and outer walls and a top end with an orifice for receiving said substrate and, optionally, a bottom end with an aperture; and
2) an inlet for dispensing at least one elution reagent;
wherein said elution station comprises sealing means and a cover removably engaged to said sealing means.

19. The apparatus of claim 18, wherein the sample is on a substrate.

20. The apparatus of claim 19, wherein the substrate is a magnetic or nonmagnetic microparticle.

21. The apparatus of claim 19, wherein the substrate comprises a lysing compound.

22. The apparatus of claim 19, wherein the substrate comprises a membrane.

23. The apparatus of claim 20, wherein the magnetic or non-magnetic microparticle bead comprises a receptor.

24. The apparatus of claim 20, wherein the substrate is selected from the group consisting of treated membranes, untreated membranes, cellulosics, cellulose nitrate, cellulose acetate, nylon, glass fiber, electrically charged substrates with corona, beads, silica, glass, plastics, clays, ceramics, resins, fibers, fabrics, microparticle beads, beads coated with oligonucleotide probes, antibody-coated beads, strepavidin-coated beads, protein-coated beads, beads coated with intercalating dyes, woven porous polymers, non-woven porous polymers, polyesters, polypropylenes, and combinations thereof.

25. The apparatus of claim 18, wherein the substance is a nucleic acid, macromolecule, protein, cell, pathogen or microorganism.

26. The apparatus of claim 18, wherein the sample is blood, lymph, animal tissue, plant tissue, cells, sub-cellular preparations, bacterial culture, bacterial colonies, virus-containing preparations, saliva, urine, drinking water, plasma, feces, sputum, semen, embryo/fetal tissue or a mixture of any of the foregoing.

27. The apparatus of claim 18, wherein the apparatus is automated.

28. The apparatus of claim 18, further comprising an agitation element.

29. The apparatus of claim 28, wherein said agitation element is mechanical motion, mechanical vibration, electrical, ultrasonic, piezoelectric, magnetic, pulsating motion, vortex, pneumatic air or gas, hydraulic, aerating, encapsulated rotating magnets, rotating stirrers and paddles, orbital shakers or combinations thereof.

30. The apparatus of claim 18, wherein said washing reagent and/or said elution reagent is aqueous.

31. The apparatus of claim 18, wherein said washing reagent or said elution reagent is, separately or together, a buffer, surfactant, water, organics or alcohol.

32. The apparatus of claim 18, wherein said washing reagent comprises a lysing compound.

33. An apparatus for purifying or isolating one or more substances from a sample comprising said one or more substances, comprising:
a) at least one lollypad comprising a substrate and handle means removably or fixedly engaged to a carrying rod, wherein said substrate removably binds the sample;
b) a dispensing station comprising dispensing means for applying the sample onto the substrate of the lollypad;
c) a transfer apparatus for transferring said lollypad from the dispensing station to a gravity flow reaction station and/or a gravity flow elution station;
d) at least one gravity flow washing station comprising:
i) a reaction chamber comprising:
1) a hollow chamber for receiving said lollypad into said chamber and having inner and outer walls and a top end with an orifice and a bottom end with an aperture;
2) an inlet for dispensing at least one washing reagent; and
3) an outlet for draining said washing reagent,
ii) a movable reaction chamber holder removably engaged to said reaction chamber; and
iii) a collection container for receiving the washing reagents on a movable base,
wherein said container comprises a top with an opening, sides and bottom wherein a plunger is affixed to the bottom of the container, and the reaction chamber passes through the opening on the top of the container and comes into contact with the plunger, and said base and said reaction chamber holder move, independent of each other or together, horizontally, vertically or diagonally, or combinations thereof; and
e) at least one gravity flow elution station comprising:
a reaction chamber comprising:
1) a hollow chamber housed in an elution heating block, said hollow chamber comprising inner and outer walls and an opening for receiving said lollypad and, optionally, a bottom end with an aperture; and
2) an inlet for dispensing at least one elution reagent;
wherein said elution heating block comprises sealing means and a cover removably engaged to said sealing means.

34. The apparatus of claim 33, further comprising a peristaltic pump for recirculating said washing reagent in a continuous or intermittent manner.

35. The apparatus of claim 33, wherein the substance is a nucleic acid, macromolecule, protein, prokaryotic cell, eukaryotic cell, or virus.

36. The apparatus of claim 33, wherein the sample is blood, animal tissue, plant tissue, cells, sub-cellular preparations, bacterial culture, bacterial colonies, virus-containing preparations, saliva, urine, drinking water, plasma, feces, sputum, semen, embryo/fetal tissue or a mixture of any of the foregoing.

37. The apparatus of claim 33, wherein the substrate is selected from the group consisting of treated membranes, untreated membranes, cellulosics, cellulose nitrate, cellulose acetate, nylon, glass fiber, electrically charged substrates with corona, beads, silica, glass, plastics, clays, ceramics, resins, fibers, fabrics, microparticle beads, beads coated with oligonucleotide probes, antibody-coated beads, strepavidin-coated beads, protein-coated beads, beads coated with intercalating dyes, woven porous polymers, non-woven porous polymers, polyesters, polypropylenes, and combinations thereof.

38. The apparatus of claim 33, wherein the substrate lyses the sample.

39. The apparatus of claim 33, wherein the apparatus is automated.

40. The apparatus of claim 33, further comprising an agitation element.

41. The apparatus of claim 40, wherein said agitation element is mechanical motion, mechanical vibration, ultrasonic, piezoelectric, magnetic, pulsating motion, vortex, pneumatic air or gas, hydraulic, aerating, encapsulated rotating magnets, rotating stirrers and paddles, orbital shakers or combinations thereof.

42. The apparatus of claim 33, wherein said washing reagent and/or said elution reagent is aqueous.

43. The apparatus of claim 33, wherein said reagent is a buffer, surfactant, water, organics or alcohol.

44. The apparatus of claim 33, wherein up to about 200 lollypads are processed at the same time.

45. The apparatus of claim 44, wherein from about 4 to 50 lollypads are processed at the same time.

46. The apparatus of claim 44, wherein from about 100 to 200 lollypads are processed at the same time.

47. The apparatus of claim 33, wherein said lollypad comprises an identification element.

48. The apparatus of claim 47, wherein said identification element comprises a barcode.

49. An apparatus for purifying or isolating one or more substances from a biological sample comprising said one or more substances, comprising:
a) at least one lollypad comprising a substrate and handle means removably or fixedly engaged to a carrying rod, wherein said substrate removably binds the biological sample;
b) a dispensing station comprising dispensing means for applying the biological sample onto the substrate of the lollypad;
c) a transfer apparatus for transferring said lollypad from the dispensing station to a gravity flow reaction station and/or a gravity flow elution station;
d) at least one gravity flow washing station comprising:
i) a reaction chamber comprising:
1) a hollow chamber for receiving said lollypad into said chamber and having inner and outer walls and a top end with an orifice and a bottom end with an aperture;
2) an inlet for dispensing at least one washing reagent; and
3) an outlet for draining said washing reagent;
ii) a movable reaction chamber holder removably engaged to said reaction chamber; and
iii) a collection container for receiving the washing reagents on a movable base,
wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally, or combinations thereof; and
e) at least one gravity flow elution station comprising:
a reaction chamber comprising:
1) a hollow chamber housed in an elution heating block, said hollow chamber comprising inner and outer walls and a top end with an opening for receiving said lollypad and, optionally, a bottom end with an aperture; and
2) an inlet for dispensing at least one elution reagent;
wherein said elution heating block comprises sealing means and a cover removably engaged to said sealing means.

50. An apparatus for collecting, storing or archiving one or more substances from a biological sample comprising said one or more substances, comprising:
a) at least one lollypad comprising a substrate and handle means removably or fixedly engaged to a carrying rod, wherein said substrate removably binds the biological sample;
b) a dispensing station comprising dispensing means for applying the biological sample onto the substrate of the lollypad; and
c) an identification element for identifying said lollypad.

51. The apparatus of claim 50, wherein said identification element comprises a barcode.

52. The apparatus of claim 50, wherein the substance is a nucleic acid, macromolecule, protein, prokaryotic cell, eukaryotic cell, virus or a mixture of any of the foregoing.

53. The apparatus of claim 50, wherein the biological sample is blood, animal tissue, plant tissue, cells, sub-cellular preparations, bacterial culture, bacterial colonies, virus-containing preparations, saliva, urine, drinking water, plasma, feces, sputum, semen, embryo/fetal tissue or a mixture of any of the foregoing.

54. The apparatus of claim 50, wherein the substrate is selected from the group consisting cellulosics, woven porous polymers, non-woven porous polymers, polyesters, polypropylenes, or beads.

55. The apparatus of claim 50, wherein the substrate lyses the biological sample.

56. The apparatus of claim 50, wherein the apparatus is automated.

57. The apparatus of claim 50, wherein up to about 200 lollypads are processed at the same time.

58. The apparatus of claim 50, wherein from about 4 to 50 lollypads are processed at the same time.

59. The apparatus of claim 50, wherein from about 100 to 200 lollypads are processed at the same time.

60. An apparatus for purifying, isolating, collecting, storing or archiving one or more substances from a sample comprising said one or more substances, comprising:
i) a reaction chamber comprising:
1) a hollow chamber for receiving said sample into said chamber and having inner and outer walls and a top end with an orifice and a bottom end with an aperture;
2) an inlet for dispensing at least one washing reagent; and
3) an outlet for draining said washing reagent,
ii) a movable reaction chamber holder removably engaged to said reaction chamber; and
iii) a collection container for receiving the washing reagents on a movable base,
wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture of the hollow chamber.

61. An apparatus for purifying or isolating one or more substances from a biological sample contained on a lollypad, comprising:
a) a transfer apparatus for transferring said lollypad from the dispensing station to a gravity flow reaction station and/or a gravity flow elution station;
b) at least one gravity flow washing station comprising:
i) a reaction chamber comprising:
1) a hollow chamber for receiving said lollypad into said chamber and having inner and outer walls and a top end with an orifice and a bottom end with an aperture;
2) an inlet for dispensing at least one washing reagent; and
3) an outlet for draining said washing reagent,
ii) a movable reaction chamber holder removably engaged to said reaction chamber; and
iii) a collection container for receiving the washing reagents on a movable base,
wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture of the hollow chamber; and
c) at least one gravity flow elution station comprising:
a reaction chamber comprising:
1) a hollow chamber housed in an elution heating block, said hollow chamber comprising inner and outer walls and a top end with an opening for receiving said lollypad; and
2) an inlet for dispensing at least one elution reagent,
wherein said elution heating block comprises sealing means and a cover removably engaged to said sealing means.

62. An apparatus comprising a rod assembly and a plurality of lollypads, comprising a substrate and a handle means, said rod assembly and plurality of lollypads being an integrally molded unit.

63. A method for purifying or isolating one or more substances from a biological sample comprising said one or more substances, comprising:
a) dispensing an aliquot of the biological sample, from a dispensing station comprising dispensing means, onto a substrate on at least one lollypad, wherein said lollypad comprises handle means removably engaged to a carrying rod;
b) transferring the lollypad containing the biological sample to at least one gravity flow washing station, said station comprising:
i) a reaction chamber comprising:
1) a hollow chamber for receiving said lollypad into said chamber and having inner and outer walls and a top end with an orifice and a bottom end with an aperture;
2) an inlet for dispensing at least one washing reagent; and
3) an outlet for draining said washing reagent,
ii) a movable reaction chamber holder removably engaged to said reaction chamber; and
iii) a collection container for receiving the washing reagents on a movable base,
wherein said container comprises a top with an opening, sides and bottom wherein a plunger affixed to the bottom of the container, and the reaction chamber passes through the opening on the top of the container and comes into contact with the plunger, and said base and said reaction chamber holder move, independent of each other or together, horizontally, vertically or diagonally in order for the plunger to seal or open the aperture of the hollow chamber;
c) washing the substrate one or more times by dispensing the washing reagent into the hollow chamber when the plunger is engaged to the chamber, allowing the reagent to come into contact with the substrate, disengaging the plunger from the chamber thereby releasing the reagent into the disposal chamber, and, optionally, drying the sample with air;
d) optionally repeating step c);
e) transferring the substrate to at least one gravity elution station for eluting the substance from the substrate, said elution station comprising a reaction chamber comprising:
1) a hollow chamber housed in an elution heating block, said hollow chamber comprising inner and outer walls and an opening for receiving said lollypad; and
2) an inlet for dispensing at least one elution reagent,
wherein said elution heating block comprises sealing means and a cover removably engaged to said sealing means.

64. The method of claim 64, wherein the substance is a nucleic acid, macromolecule, protein, cell, pathogen, microorganism or a mixture of any of the foregoing.

65. The method of claim 64, wherein the biological sample is blood, animal tissue, plant tissue, cells, sub-cellular preparations, bacterial culture, bacterial colonies, virus-containing preparations, saliva, urine, drinking water, plasma, feces, sputum, semen, embryo/fetal tissue or a mixture of any of the foregoing.

66. The method of claim 64, wherein the substrate comprises a substrate selected from the group consisting of cellulosics, woven porous polymers, non-woven porous polymers, polyesters, polypropylenes, or beads.

67. The method of claim 64, wherein the substrate lyses the biological sample.

68. The method of claim 64, further comprising an agitation element.

69. The method of claim 68, wherein the agitation element is mechanical, ultrasonic, magnetic or electromagnetic.

70. The method of claim 64, wherein up to about 200 lollypads are processed at the same time.

71. The method of claim 64, wherein from about 4 to 50 lollypads are processed at the same time.

72. The method of claim 64, wherein from about 100 to 200 lollypads are processed at the same time.

73. A method for collecting, storing or archiving one or more substances from a biological sample comprising said one or more substances, comprising:
a) dispensing an aliquot of the biological sample, from a dispensing station comprising dispensing means, onto a substrate on at least one lollypad, wherein said lollypad comprises handle means removably engaged to a carrying rod; and
b) identifying said lollypad with an identification element.

74. The method of claim 73, wherein said identification element comprises a barcode.

75. The method of claim 73, wherein the substance is a nucleic acid, macromolecule, protein, cell, pathogen, a microorganism or a mixture of any of the foregoing.

76. The method of claim 73, wherein the biological sample is blood, animal tissue, plant tissue, cells, sub-cellular preparations, bacterial culture, virus-containing preparations, saliva, urine, drinking water, plasma, feces, sputum, semen, embryo/fetal tissue or a mixture of any of the above.

77. The method of claim 73, wherein the substrate is selected from the group consisting of cellulosics, woven porous polymers, non-woven porous polymers, polyesters, polypropylenes, beads, magnetic microparticles or non-magnetic microparticles.

78. The method of claim 73, wherein the substrate lyses the biological sample.

79. The method of claim 73, further comprising an agitation element.

80. The method of claim 73, wherein the agitation element is mechanical, ultrasonic magnetic or electromagnetic.

81. The method of claim 73, wherein up to about 200 lollypads are processed at the same time.

82. The method of claim 73, wherein from about 4 to 50 lollypads are processed at the same time.

83. The method of claim 73, wherein from about 100 to 200 lollypads are processed at the same time.

84. A gravity flow elution station for purifying, isolating, collecting, storing or archiving one or more substances from a biological sample comprising said one or more substances, comprising a reaction chamber comprising:
1) a hollow chamber housed in an elution heating block, said hollow chamber comprising inner and outer walls and a top end with an opening for receiving a substrate; and
2) an inlet for dispensing at least one elution reagent,
wherein said elution heating block comprises sealing means and a cover removably engaged to said sealing means.

85. An apparatus for purifying, isolating, collecting, storing or archiving one or more substances from a sample comprising said one or more substances, comprising a collection container for receiving washing reagents on a movable base, wherein said container comprises a top with an opening, sides and bottom wherein a plunger affixed to the bottom of the container comes into contact with an aperture on a reaction chamber, said reaction chamber passing through the opening on the top of the container and held by a reaction chamber holder, wherein said base and said reaction chamber holder move, independent of each other or together, horizontally, vertically or diagonally in order for the plunger to seal or open the aperture of the reaction chamber.
